(19) United States
(12) Patent Application Publication
(10) Pub. No.: US 2024/0358015 A1
(43) Pub. Date: Oct. 31, 2024

(54) HERBICIDAL COMPOSITIONS

(71) Applicant: Agrematch Ltd., Rehovot (IL)

(72) Inventors: Ifat SHUB, RaAnana (IL); Yael PHILLIP, Nes-Ziona (IL); Yosef GEVA, Hatzor Ashdod (IL)

(73) Assignee: Agrematch Ltd., Rehovot (IL)

(21) Appl. No.: 18/577,309

(22) PCT Filed: Jul. 6, 2022
(86) PCT No.: PCT/IL2022/050727

§ 371 Date: Jan. 8, 2024

(30) Foreign Application Priority Data
Jul. 8, 2021 (IL) 284728
Jul. 8, 2021 (IL) 284729

(51) Int. Cl. A01N 35/06; A01N 25/04; A01N 25/30; A01P 13/00

(52) U.S. Cl. CPC A01N 35/06; A01N 25/04; A01N 25/30; A01P 13/00

(57) ABSTRACT

Compositions for use in controlling a growth of a plant substrate, and/or for inhibiting growth of a herb in the vicinity of a plant substrate are provided. The compositions comprise an agriculturally acceptable carrier and an anthraquinone compound represented by Formula I as defined in the specification.

### RELATED APPLICATION/S

This application claims the benefit of priority of Israel Patent Application Nos. 284728 and 284729, filed on Jul. 8, 2021, the contents of which are incorporated herein by reference in their entirety.

### FIELD AND BACKGROUND OF THE INVENTION

The present invention, in some embodiments thereof, relates to crop protection and, more particularly, but not exclusively, to novel compositions that are usable in promoting growth of plants by inhibiting growth of herbs and/or pests, and to methods employing such compositions.

Weeds are plants that compete with cultivated plants in an agronomic environment. Weeds also serve as hosts for crop diseases and insect pests. The losses caused by weeds in agricultural production environments include decreases in crop yield, reduced crop quality, increased irrigation costs, increased harvesting costs, reduced land value, injury to livestock, and crop damage from insects and diseases harbored by the weeds.

Herbicide tolerant weeds are a problem with nearly all herbicides in use. There are over 350 weed biotypes identified as being herbicide resistant to one or more herbicides by the Herbicide Resistance Action Committee (HRAC), the North American Herbicide Resistance Action Committee (NAHRAC), and the Weed Science Society of America (WSSA).

Anthraquinones, or anthraquinone derivatives, have been described in the art as exhibiting certain phytotoxic effects.

Oettmeier et al., FEBS Letters, 1988, Volume 231, No. 1, pages 259-262, describe studies conducted for evaluating the activity of various substituted anthraquinone as photosystem II inhibitors (inhibitors of photosynthesis). The studies were conducted using chloroplast from spinach, in a system intended to prevent electron flow through photosystem I, and it was determined that hydroxy and/or methoxy substitutions at positions 1 and/or 8 render the anthraquinone highly active in inhibiting photosystem II. This document is silent with regard to weeds, let alone with regard to herbicidal resistance, and is further silent with regard to formulations suitable for applying the anthraquinones to plants.

Schrader et al., Int. J. Plant Sci. 161 (2): 265-270, 2000, teach that 9,10-anthraquinone (unsubstituted) inhibits growth of a cyanobacterium, presumably via inhibition of photosystem II.

Andolfi et al., J. Agric. Food Chem. 2013, 61, 7301-7308, describe an anthraquinone produced from lentil, which was shown to be phytotoxic to various legumes. This document is silent with regard to weeds, let alone with regard to herbicidal resistance, and is further silent with regard to formulations suitable for applying the anthraquinones.

GB Patent No. 1,382,721 teaches 1-anthraquinonyloxy compounds as herbicides effective against weeds, including aquatic weeds and terrestrial weeds. This documents discusses formulations such as aqueous dispersions, optionally in combination with an organic solvent, and mentions generally inclusion of dispersants, surfactants and emulsifiers.

DeLiberto and Werner, Pest Manag Sci 2016; 72:1813-1825, is a review on anthraquinones as chemical repellents, while focusing on avian species. This review is silent with regard to weeds, let alone with regard to herbicidal resistance, and is further silent with regard to formulations suitable for applying the anthraquinones.

U.S. Patent Application Publication No. 2018/0295842 describes anthraquinone-containing formulations for use as biopesticides and herbicides. The anthraquinones are preferably derived from plants, and can be substituted at any position by hydroxy, hydroxyalkyl, halogen, carboxyl, alkyl, alkoxy, sugars and more. This document describes various optional formulations, and teaches that a suitable formulation is selected in accordance with the plant extract at hand. This document teaches that anthraquinone derivatives such as rhein, emodin, aloe emodin, parietin (physcion), emodin glycoside, physcion glycoside, chrysophanol and chrysophanol glycoside were shown to induce plant resistance to pathogens.

### SUMMARY OF THE INVENTION

According to an aspect of some embodiments of the present invention there is provided a composition for use in controlling a growth of a plant substrate, the composition comprising an agriculturally acceptable carrier and a compound represented by Formula I:

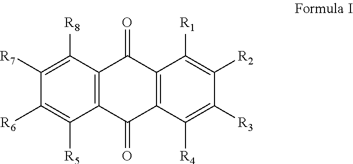

wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is selected from hydrogen, OR₉, —C(═O)—OR₁₀, and hydroxyalkyl;
R₄ is selected from hydrogen, OR₉ and amine;
R₅ and R₇ are each hydrogen;
R₆ is selected from hydrogen and alkyl;
R₉ is selected from hydrogen, a saccharide, and —C(═O)—R₁₁;
R₁₀ is selected from hydrogen and alkyl; and
R₁₁ is alkyl, provided that at least one of R₁, R₂, R₃ and R₈, or at least R₃, is —C(═O)—OR₁₀.

According to some of any of the embodiments described herein, the carrier is an aqueous carrier.

According to some of any of the embodiments described herein, R₃ is —C(═O)—OR₁₀.

According to some of any of the embodiments described herein, the compound is represented by Formula Ia:

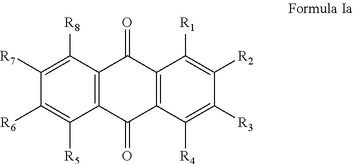

wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is —C(═O)—OR₁₀;
R₄ is selected from hydrogen, OR₉ and amine;
R₅-R₇ are each hydrogen;
R₉ is selected from hydrogen, a saccharide, and —C(═O)—R₁₁;
R₁₀ is selected from hydrogen and alkyl; and
R₁₁ is alkyl.

According to some of any of the embodiments described herein, R₁ and R₈ are each independently OR₉.

According to some of any of the embodiments described herein, R₁ and R₈ are each OR₉, and wherein each R₉ is hydrogen.

According to some of any of the embodiments described herein, R₁ and R₈ are each OR₉, and wherein each R₉ is —C(═O)—R₁₁.

According to some of any of the embodiments described herein, each R₁₁ is alkyl, preferably, methyl.

According to some of any of the embodiments described herein, R₁ and R₈ are each independently OR₉, and wherein in at least one of the OR₉, R₉ is a saccharide.

According to some of any of the embodiments described herein, R₄ is OR₉.

According to some of any of the embodiments described herein, R₁, R₂ and R₅-R₈ are each hydrogen.

According to some of any of the embodiments described herein, R₉ is hydrogen.

According to some of any of the embodiments described herein, R₁, R₂ and R₅-R₈ are each hydrogen.

According to some of any of the embodiments described herein, the compound is selected from Compound 1, Compound 1A, Compound 1B, Compound 2 and Compound 3.

According to some of any of the embodiments described herein, the carrier comprises at least one adjuvant.

According to some of any of the embodiments described herein, a total amount of the adjuvant ranges from about 0.1% to about 10%, by weight of the total weight of the composition.

According to some of any of the embodiments described herein, the adjuvant is selected from the adjuvants presented in Tables 1A and 1B.

According to some of any of the embodiments described herein, the adjuvant comprises at least one surfactant.

According to some of any of the embodiments described herein, the adjuvant comprises at least one non-ionic surfactant.

According to some of any of the embodiments described herein, the adjuvant comprises at least one polyethoxylated surfactant.

According to some of any of the embodiments described herein, the adjuvant comprises at least one polyethoxylated sorbitan mono-ester surfactant.

According to some of any of the embodiments described herein, an amount of the at least one polyethoxylated sorbitan mono-ester surfactant is at least 1%, or ranges from 1 to 5%, by weight, of the total weight of the composition.

According to some of any of the embodiments described herein, the aqueous carrier is in a form of an emulsion and further comprises an organic solvent.

According to some of any of the embodiments described herein, the organic solvent comprises at least one polar aprotic organic solvent.

According to some of any of the embodiments described herein, the organic solvent comprises a mixture of a ketone and a pyrrolidone.

According to some of any of the embodiments described herein, a weight ratio of the ketone and the pyrrolidone ranges from 2:1 to 10:1, or from 2:1 to 6:1.

According to some of any of the embodiments described herein, an amount of the organic solvent ranges from 5 to 20%, by weight, of the total weight of the composition.

According to some of any of the embodiments described herein, the carrier further comprises at least one emulsifier.

According to some of any of the embodiments described herein, the at least one emulsifier comprises an alkyl sulfonate, an aryl sulfonate and/or and alkaryl sulfonate.

According to some of any of the embodiments described herein, the at least one emulsifier comprises an ethoxylated mineral oil.

According to some of any of the embodiments described herein, an amount of the at least one emulsifier ranges from 0.1 to 2% by weight of the total weight of the composition.

According to some of any of the embodiments described herein, the carrier is an aqueous carrier and further comprises:
from about 1 to about 20, or from about 5 to about 15, % by weight of an organic solvent that comprises a mixture of a ketone and a pyrrolidone at a weight ratio that ranges from 2:1 to 6:1;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition; and, optionally,
a polyether-modified polysiloxane emulsifier in an amount that ranges from 0.01 to 0.1, or of about 0.05, % by weight, of the total weight of the composition.

According to some of any of the embodiments described herein, the carrier comprises an alkaline substance.

According to some of any of the embodiments described herein, a mol ratio of the alkaline substance to the compound ranges from 2:1 to 1:1 or is about 1.

According to some of any of the embodiments described herein, the alkaline substance is selected from an alkaline buffer, an amine, an alkali metal hydroxide and an ammonium hydroxide.

According to an aspect of some embodiments of the present invention there is provided a composition for use in controlling a growth of a plant substrate, the composition comprising an agriculturally acceptable carrier and a compound represented by Formula Ia:

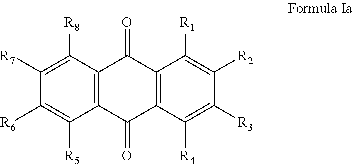

wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is —C(═O)—OR₁₀;
R₄ is selected from hydrogen, OR₉ and amine;
R₅-R₇ are each hydrogen;
R₉ is selected from hydrogen, a saccharide, and —C(═O)—R₁₁;
R₁₀ is selected from hydrogen and alkyl; and
R₁₁ is alkyl,
and wherein the carrier is an aqueous carrier and further comprises:
an alkaline substance in a mol ratio of from 2:1 to 1:1 relative to the compound of Formula Ia; and
at least one adjuvant that comprises a non-ionic surfactant in an amount of from 0.1 to 5% by weight of the total weight of the composition.

According to an aspect of some embodiments of the present invention there is provided a composition for use in controlling a growth of a plant substrate, the composition comprising an agriculturally acceptable carrier and a compound represented by Formula I:

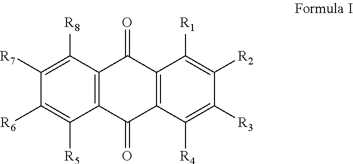

wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is selected from hydrogen, OR₉, —C(═O)—OR₁₀, and hydroxyalkyl;
R₄ is selected from hydrogen, OR₉ and amine;
R₅ and R₇ are each hydrogen;
R₆ is selected from hydrogen and alkyl;
R₉ is selected from hydrogen, a saccharide, and —C(═O)—R₁₁;
R₁₀ is selected from hydrogen and alkyl; and
R₁₁ is alkyl,
provided that:
at least one of R₁, R₂, R₃ and R₈, or at least R₃, is —C(═O)—OR₁₀; or
at least one of R₁ and R₄ is amine; or
when R₃ is hydroxyalkyl, each of R₁ and R₈ is other than OR₉ wherein R₉ is hydrogen or saccharide; or
when R₁ is OR₉ wherein R₉ is hydrogen, each of R₂-R₈ is hydrogen; or
R₃ is other than OR₉,
wherein the carrier is an aqueous carrier, the aqueous carrier being in a form of an emulsion and further comprises an organic solvent, at least one emulsifier and at least one adjuvant,
wherein the organic solvent comprises at least one polar aprotic organic solvent;
an amount of the organic solvent ranges from about 5 to about 20, or from about 5 to about 15, % by weight, of the total weight of the composition;
the at least one emulsifier is in an amount that ranges from 0.1 to 2% by weight of the total weight of the composition; and
the at least one adjuvant is in an amount that ranges from about 0.1% to about 10%, by weight of the total weight of the composition.

According to some of any of the embodiments described herein, the organic solvent comprises at least one polar aprotic organic solvent.

According to some of any of the embodiments described herein, the organic solvent comprises a mixture of a ketone and a pyrrolidone.

According to some of any of the embodiments described herein, a weight ratio of the ketone and the pyrrolidone ranges from 2:1 to 10:1, or from 2:1 to 6:1.

According to some of any of the embodiments described herein, the at least one emulsifier comprises an alkyl sulfonate, an aryl sulfonate and/or and alkaryl sulfonate.

According to some of any of the embodiments described herein, the at least one emulsifier comprises an ethoxylated mineral oil.

According to some of any of the embodiments described herein, the carrier is an aqueous carrier and further comprises:
from about 5 to about 20, or from about 5 to about 15, % by weight of an organic solvent that comprises a mixture of a ketone and a pyrrolidone at a weight ratio that ranges from 2:1 to 6:1;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition.

According to some of any of the embodiments described herein, the adjuvant is selected from the adjuvants presented in Tables 1A and 1B.

According to some of any of the embodiments described herein, the adjuvant comprises at least one surfactant.

According to some of any of the embodiments described herein, the adjuvant comprises at least one non-ionic surfactant.

According to some of any of the embodiments described herein, the adjuvant comprises at least one polyethoxylated surfactant.

According to some of any of the embodiments described herein, the adjuvant comprises at least one polyethoxylated sorbitan mono-ester surfactant.

According to some of any of the embodiments described herein, an amount of the at least one polyethoxylated sorbitan mono-ester surfactant is at least 1%, or ranges from 1 to 5%, by weight, of the total weight of the composition.

According to some of any of the embodiments described herein, the at least one adjuvant comprises a polyether-modified polysiloxane.

According to some of any of the embodiments described herein, an amount of the polyether-modified polysiloxanes ranges from 0.01 to 0.1, or of about 0.05, % by weight, of the total weight of the composition.

According to some of any of the embodiments described herein, at least one of R₁ and R₄ is amine.

According to some of any of the embodiments described herein, R₁ is OR₉ and R₄ is amine.

According to some of any of the embodiments described herein, R₉ is hydrogen.

According to some of any of the embodiments described herein, R₃ is hydroxyalkyl.

According to some of any of the embodiments described herein, the compound is selected from Compound 4, Compound 5, Compound 6, and Compound 7.

According to an aspect of some embodiments of the present invention there is provided a composition for use in controlling a growth of a plant substrate, the composition comprising an agriculturally acceptable carrier and a compound represented by Formula I:

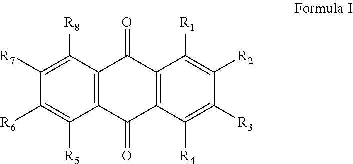

wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is hydroxyalkyl;
R₄ is selected from hydrogen, OR₉ and amine;
R₅-R₇ are each hydrogen;
R₉ is selected from hydrogen, a saccharide, and —C(═O)—R₁₁;
R₁₀ is selected from hydrogen and alkyl; and
R₁₁ is alkyl,
provided that each of R₁ and R₈ is other than OR₉ wherein R₉ is hydrogen or saccharide,
and wherein the carrier is an aqueous carrier and further comprises:
from about 1 to about 20, or from about 5 to about 15, % by weight of an organic solvent that comprises a mixture of a ketone and a pyrrolidone at a weight ratio that ranges from 2:1 to 6:1;
at least one adjuvant that comprises a non-ionic surfactant, in a total amount that ranges from 0.1 to 5, or from 1 to 5, % by weight of the total weight of the formulation;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition.

According to some of any of the embodiments described herein, R₁, R₂ and R₄-R₈ are each hydrogen.

According to an aspect of some embodiments of the present invention there is provided a composition for use in controlling a growth of a plant substrate, the composition comprising an agriculturally acceptable carrier and a compound represented by Formula I:

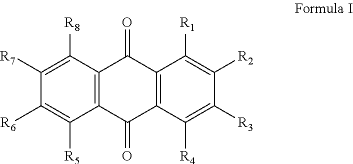

wherein:
R₁, R₃ and R₈ are each OR₉;
R₂ is hydrogen;
R₄ is selected from hydrogen, OR₉ and amine;
R₅ and R₇ are each hydrogen;
R₆ is alkyl;
R₉ is selected from hydrogen, a saccharide, and —C(═O)—R₁₁; and
R₁₁ is alkyl,
and wherein the carrier is an aqueous carrier and further comprises:
from about 1 to about 20, or from about 5 to about 15, % by weight of an organic solvent that comprises a mixture of a ketone and a pyrrolidone at a weight ratio that ranges from 2:1 to 6:1;
at least one adjuvant that comprises a non-ionic surfactant, in a total amount that ranges from 0.1 to 5, or from 1 to 5, % by weight of the total weight of the formulation;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition.

According to some of any of the embodiments described herein, R₄ is hydrogen, and in each of R₁, R₃ and R₈, R₉ is hydrogen.

According to an aspect of some embodiments of the present invention there is provided a composition for use in controlling a growth of a plant substrate, the composition comprising an agriculturally acceptable carrier and a compound represented by Formula I:

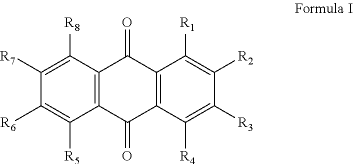

wherein:
R₁ is OR₉;
R₂-R₈ are each hydrogen;
R₉ is selected from hydrogen, a saccharide, and —C(═O)—R₁₁; and
R₁₁ is alkyl,
and wherein the carrier is an aqueous carrier and further comprises:
from about 1 to about 20, or from about 5 to about 15, % by weight of an organic solvent that comprises a mixture of a ketone and a pyrrolidone at a weight ratio that ranges from 2:1 to 6:1;
at least one adjuvant that comprises a non-ionic surfactant, in a total amount that ranges from 0.1 to 5, or from 1 to 5, % by weight of the total weight of the formulation;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition.

According to some of any of the embodiments described herein, R₉ is hydrogen.

According to an aspect of some embodiments of the present invention there is provided a composition for use in controlling a growth of a plant substrate, the composition comprising an agriculturally acceptable carrier and a compound represented by Formula I:

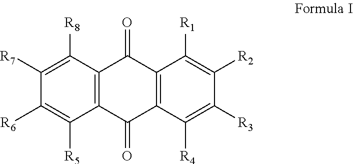

wherein:
R₁ is OR₉;
R₂, R₃ and R₅-R₈ are each independently selected from hydrogen, OR₉, and —C(═O)—OR₁₀;
R₄ is amine;
R₉ is selected from hydrogen, a saccharide, and —C(═O)—R₁₁;
R₁₀ is selected from hydrogen and alkyl; and
R₁₁ is alkyl,
and wherein the carrier is an aqueous carrier and further comprises:
from about 1 to about 20, or from about 5 to about 15, % by weight of an organic solvent that comprises a mixture of a ketone and a pyrrolidone at a weight ratio that ranges from 2:1 to 6:1;
at least one adjuvant that comprises a non-ionic surfactant, in a total amount that ranges from 0.1 to 5, or from 1 to 5, % by weight of the total weight of the formulation;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition.

According to some of any of the embodiments described herein, R₂, R₃ and R₅-R₈ are each hydrogen.

According to some of any of the embodiments described herein, the composition comprises comprising at least one adjuvant.

According to some of any of the embodiments described herein, a total amount of the at least one adjuvant ranges from about 0.1% to about 10%, by weight of the total weight of the composition.

According to some of any of the embodiments described herein, the adjuvant is selected from the adjuvants presented in Tables 1A and 1B.

According to some of any of the embodiments described herein, the adjuvant comprises at least one surfactant.

According to some of any of the embodiments described herein, the adjuvant comprises at least one non-ionic surfactant.

According to some of any of the embodiments described herein, the adjuvant comprises at least one polyethoxylated surfactant.

According to some of any of the embodiments described herein, the adjuvant comprises at least one polyethoxylated sorbitan mono-ester surfactant.

According to some of any of the embodiments described herein, an amount of the at least one polyethoxylated sorbitan mono-ester surfactant is at least 1%, or ranges from 1 to 5%, by weight, of the total weight of the composition.

According to some of any of the embodiments described herein, the at least one adjuvant comprises a polyether-modified polysiloxane.

According to some of any of the embodiments described herein, an amount of the polyether-modified polysiloxanes ranges from 0.01 to 0.1, or of about 0.05, % by weight, of the total weight of the composition.

According to some of any of the embodiments described herein, a composition as described herein in any of the respective embodiments and any combination thereof is an herbicidal composition.

According to some of any of the embodiments described herein, a composition as described herein in any of the respective embodiments and any combination thereof is for inhibiting growth of a herb (e.g., weed) in the vicinity of the plant substrate.

According to some of any of the embodiments described herein, the weed is an Amaranthus species.

According to some of any of the embodiments described herein, the weed is Amaranthus Palmeri (A. Palmeri).

According to some of any of the embodiments described herein, the weed is selected from Echinochloa colonum, Lolium multiflorum and Solanum nigrum.

According to some of any of the embodiments described herein, the weed is a Setaria species.

According to some of any of the embodiments described herein, the weed is S. viridis

According to some of any of the embodiments described herein, a composition as described herein in any of the respective embodiments and any combination thereof is a pesticidal composition, for example, a fungicidal composition.

According to some of any of the embodiments described herein, a composition as described herein in any of the respective embodiments and any combination thereof is for inhibiting growth of a fungus in the plant or the vicinity of the plant.

According to some of any of the embodiments described herein, the fungus is Botrytis cinerea.

According to an aspect of some embodiments of the present invention there is provided a method of controlling a growth of a plant substrate, the method comprising contacting the plant substrate with a composition as described herein in any of the respective embodiments and any combination thereof.

According to an aspect of some embodiments of the present invention there is provided a method of inhibiting a growth of a herb (e.g., weed), the method comprising contacting the herb with a composition as described herein in any of the respective embodiments and any combination thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents the chemical structures of exemplary anthraquinone compounds according to some embodiments of the present invention.

FIG. 2 (Background Art) presents substituted anthraquinone compounds described in the art as featuring a phytotoxic activity, as taught in Oettmeier et al., FEBS Letters, 1988, Volume 231, No. 1, pages 259-262, Andolfi et al., J. Agric. Food Chem. 2013, 61, 7301-7308, GB Patent No. 1,382,721, and as mentioned in U.S. Patent Application Publication No. 2018/0295842.

### DESCRIPTION OF SPECIFIC EMBODIMENTS OF THE INVENTION

The present invention, in some embodiments thereof, relates to crop protection and, more particularly, but not exclusively, to novel compositions that are usable in promoting growth of plants by inhibiting growth of herbs and/or pests, and to methods employing such compositions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The present inventors have uncovered by in silico screening of a mega database, anthraquinone compounds, that are promising candidates for controlling a growth of a plant, by exhibiting herbicidal and/or fungicidal activity.

As demonstrated in the Examples section that follows, the present inventors have shown that compositions comprising exemplary such anthraquinones and an aqueous-based carrier efficiently inhibit the growth of a variety of unwanted herbs (e.g., weeds) and of fungal species. The present inventors have also screened various aqueous-based carriers so as to uncover the most suited carrier for the tested anthraquinones.

Embodiments of the present invention therefore relate to novel compositions that are usable for crop protection, by inhibiting growth of unwanted herbs and/or fungi and/or other unwanted pests in the vicinity of the plant.

### The Anthraquinone Compounds:

Anthraquinone compounds according to the present embodiments can be collectively represented by Formula I:

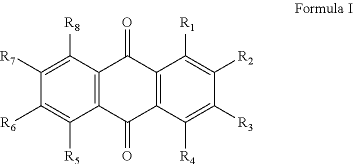

wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is selected from hydrogen, OR₉, —C(═O)—OR₁₀, and hydroxyalkyl;
R₄ is selected from hydrogen, OR₉ and amine;
R₅ and R₇ are each hydrogen;
R₆ is selected from hydrogen and alkyl;
R₉ is selected from hydrogen, a saccharide, and —C(═O)—R₁₁;
R₁₀ is selected from hydrogen and alkyl; and
R₁₁ is alkyl.

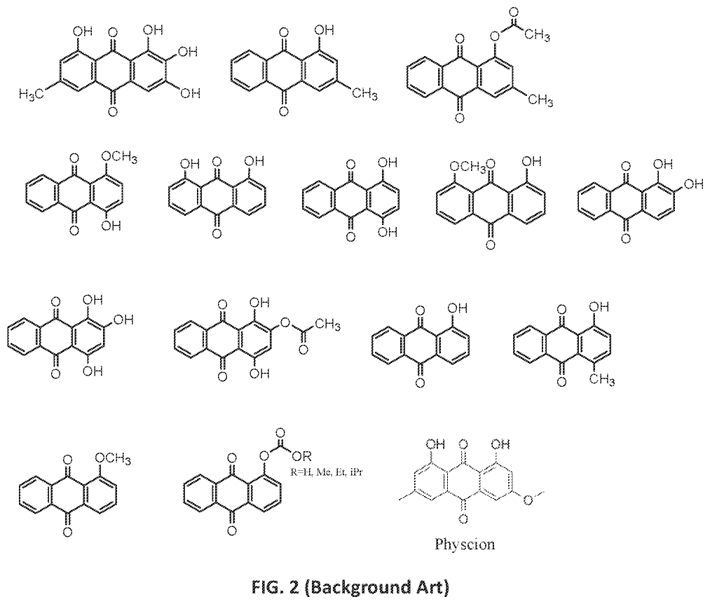

According to some of any of the embodiments described herein, compounds as presented in Background Art FIG. 2 are excluded from the scope of some embodiments of the present invention.

According to some of any of the embodiments described herein, compounds presented by Formula I are such that:
at least one of R₁, R₂, R₃ and R₈, preferably at least R₃, is —C(═O)—OR₁₀; or
at least one of R₁ and R₄ is amine; or
when R₃ is hydroxyalkyl, each of R₁ and R₈ is other than OR₉ wherein R₉ is hydrogen or saccharide; or
when R₁ is OR₉ wherein R₉ is hydrogen, each of R₂-R₈ is hydrogen; or
R₃ is other than OR₉.

According to some of any of the embodiments described herein, one or more of the substituents (R₁-R₈) is OR₉. According to some of these embodiments, R₉ is hydrogen such that one or more the substituents is hydroxy. Alternatively, R₉ is a saccharide, as defined herein, representing, for example, a glycosyl anthraquinone compound. Further alternatively, R₉ is —C(═O)—R₁₁, representing an ester derivative of the anthraquinone compound, in which Ru is an alkyl, preferably a lower alkyl or 1 to 4 carbon atoms in length, and further preferably, an unsubstituted lower alkyl, for example, methyl. Optionally, Ru can be cycloalkyl or aryl, as defined herein. Without wishing to be bound by any particular theory, it is assumed that an ester derivative acts as a “prodrug”, which decomposes upon application or formulation into a corresponding hydroxy compound.

When the compound comprises two or more substituents which are OR₉ as described herein, in each such substituents, Ry can be the same or different.

According to some embodiments of the present invention, none of the R₁-R₈ substituents is an alkyl; or, further alternatively, none of the R₁-R₈ substituents is an alkyl, a cycloalkyl or an aryl, as defined herein.

According to some of any of the embodiments described herein, one or more of the substituents (R₁-R₈) is or comprises an amine (—NR′R″). The amine can be a primary amine, in which both R′ and R″ are hydrogen, or a secondary amine, in which R′ is hydrogen and R″ is alkyl, cycloalkyl or aryl, or as defined hereinbelow, or a tertiary amine, in which R′ and R″ are each independently alkyl, cycloalkyl or aryl. Preferably, the amine is a primary amine.

According to some of these embodiments, one or both of R₁ and R₄ is amine. According to some of these embodiments, R₁ is OR₉, with Ry being as defined herein, and R₄ is amine or R₁ is amine and R₄ is OR₉, with Ry being as defined herein. According to some of any of these embodiments, R₉ is hydrogen, such that the compound is substituted by an amine and a hydroxy. According to some of any of these embodiments, R₂, R₃, and R₅-R₈ are each hydrogen. An exemplary such compound is referred to herein as Compound 7. Alternatively, R₉ is a saccharide, as defined herein, representing, for example, a glycosyl anthraquinone derivative of Compound 7. Further alternatively, R₉ is —C(═O)—R₁₁, representing an ester derivative of the anthraquinone Compound 7, in which Ru is as described herein.

According to some of any of the embodiments described herein, R₃ is hydroxyalkyl. According to some of these embodiments, the alkyl is a lower alkyl, of 1-4 carbon atoms, and is preferably a hydroxymethyl (e.g., —CH₂OH). According to some of these embodiments, each of R₁, R₂ and R₄-R₈ is hydrogen. An exemplary compound according to these embodiments is also referred to herein as Compound 4.

According to some of any of the embodiments described herein, R₁ is OR₉. According to some of these embodiments, R₉ is hydrogen such that R₁ is hydroxy. According to some of these embodiments, each of R₂-R₈ is hydrogen. An exemplary compound according to these embodiments is also referred to herein as Compound 6. Alternatively, R₉ is a saccharide, as defined herein, representing, for example, a glycosyl anthraquinone derivative of Compound 6. Further alternatively, R₉ is —C(═O)—R₁₁, representing an ester derivative of the anthraquinone compound 6, in which R₁₁ is as described herein.

According to some embodiments of the present invention, Compound 4, Compound 6 and Compound 5 are excluded from the scope of the present invention.

According to some of any of the embodiments described herein, none of the R₁-R₈ substituents is or comprises an alkyl, cycloalkyl or aryl, as defined herein.

According to some of any of the embodiments described herein, at least one of the R₁-R₈ substituents is —C(═O)—OR₁₀.

According to some of any of the embodiments described herein, at least one of R₁, R₂, R₃ and R₈ is —C(═O)—OR₁₀.

According to some of these embodiments, R₁₀ is hydrogen, such that one or more of the substituents is a carboxylic acid.

According to some of these embodiments, R₁₀ is an alkyl, preferably a lower alkyl, of 1 to 4 carbon atoms in length, for example, methyl (e.g., such that one or more the substituents is acetate). In some embodiments, the alkyl is an unsubstituted alkyl. Alternatively, R₁₀ can be a cycloalkyl or aryl, as defined herein, preferably, unsubstituted cycloalkyl or unsubstituted aryl.

According to some of any of the embodiments described herein, at least one of R₁, R₂, R₃ and R₈ is —C(═O)—OR₁₀, as described herein in any of the respective embodiments, and one or more of the other substituents is OR₉, as described herein. In some of these embodiments, R₉ is hydrogen such that the compound comprises one O-carboxy substituent and one or more hydroxy substituents.

According to some of any of the embodiments described herein, R₃ is —C(═O)—OR₁₀.

According to an aspect of some embodiments of the present invention, the anthraquinone compound is represented by Formula I as described herein in any of the respective embodiments and any combination thereof, wherein R₃ is —C(═O)—OR₁₀, with R₁₀ being as defined herein in any of the respective embodiments.

Such compounds can be collectively represented by Formula Ia:

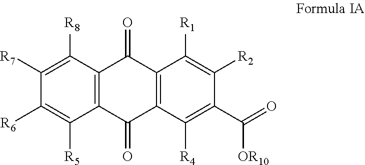

Wherein R₁, R₂ and R₄-R₁₀ are as defined herein in any of the respective embodiments and any combination thereof.

According to some of these embodiments, R₁₀ is hydrogen.

According to some of any of the embodiments described herein for Formula I in which R₃ is —C(═O)—OR₁₀, or for Formula Ia, one or more of the other substituents is OR₉, as defined herein in any of the respective embodiments. According to some of these embodiments, R₁ and R₈ are each independently OR₉. According to some of any of these embodiments, each of the one or more OR₉ substituents is such that R₉ is hydrogen. Alternatively, one or more OR₉ substituents is such that R₉ is a saccharide, representing, for example, a glycosyl derivative of the compound. Further alternatively, one or more OR₉ substituents is such that R₉—C(═O)—R₁, representing an ester derivative of the anthraquinone compound, in which Ru is as described herein

According to some of any of the embodiments described herein for Formula I in which R₃ is —C(═O)—OR₁₀, or for Formula Ia, R₁ and R₈ are each OR₉, and each R₉ is hydrogen. According to some of these embodiments, R₂ and R₄-R₇ are each hydrogen. An exemplary such compound is also referred to herein as Compound 1.

According to some of any of the embodiments described herein for Formula I in which R₃ is —C(═O)—OR₁₀, or for Formula Ia, R₁ and R₈ are each OR₉, and at least one, or each R₉ is —C(═O)—R₁₁. In some of these embodiments, one of OR₉ is hydroxy (R₉ is hydrogen) and the other is O—C(═O)—R₁₁. In some of these embodiments, each of R₁ and R₈ is —O—C(═O)—R₁₁. In some of any of these embodiments, Ru is an alkyl, as described herein. Alternatively, Ru is a cycloalkyl or aryl, as described herein. According to some of these embodiments, in each —O—C(═O)—R₁₁, R₁₁ is alkyl, preferably and unsubstituted alkyl, for example, methyl. According to some of any of these embodiments, R₂ and R₄-R₇ are each hydrogen. An exemplary such compound is also referred to herein as Compound 1A. As discussed hereinabove, such a compound represents an ester “prodrug” derivative of Compound 1 and like compounds.

According to some of any of the embodiments described herein for Formula I in which R₃ is —C(═O)—OR₁₀, or for Formula Ia, R₁ and R₈ are each OR₉, and at least one, or each R₉ is -a saccharide as defined herein. In some of these embodiments, one of OR₉ is hydroxy (R₉ is hydrogen) and the other is O—R₉ wherein R₉ is a saccharide. In some of these embodiments, each of R₁ and R₈ is O—R₉ and in each, R₉ is independently a saccharide. In some of these embodiments, one of OR₉ is hydroxy (R₉ is hydrogen) and the other is O—R₉ wherein R₉ is a saccharide. According to some of any of the embodiments described herein for Formula I in which R₃ is —C(═O)—OR₁₀, or for Formula Ia, R₁ is OR₉ and R₉ is hydroxy and R₈ is OR₉ and R₉ is -a saccharide as defined herein. According to some of any of these embodiments, R₂ and R₄-R₇ are each hydrogen. An exemplary such compound is also referred to herein as Compound 1B, and is known in the art as Rhein 8-glucoside. As discussed hereinabove, such a compound represents an ester “prodrug” derivative of Compound 1 and like compounds.

According to some of any of the embodiments described herein for Formula I in which R₃ is —C(═O)—OR₁₀, or for Formula Ia, R₄ is OR₉. In some of these embodiments, R₉ is hydrogen such that R₄ is hydroxy. Alternatively, R₉ is a saccharide or —C(═O)—R₁₁, representing a, for example, a glycoside or ester derivative, respectively, as described herein. According to some of any of these embodiments, R₁, R₂ and R₅-R₈ are each hydrogen. An exemplary such compound is also referred to herein as Compound 3.

According to some of any of the embodiments described herein for Formula I in which R₃ is —C(═O)—OR₁₀, or for Formula Ia, R₁, R₂ and R₄-R₈ are each hydrogen. An exemplary such compound is also referred to herein as Compound 2

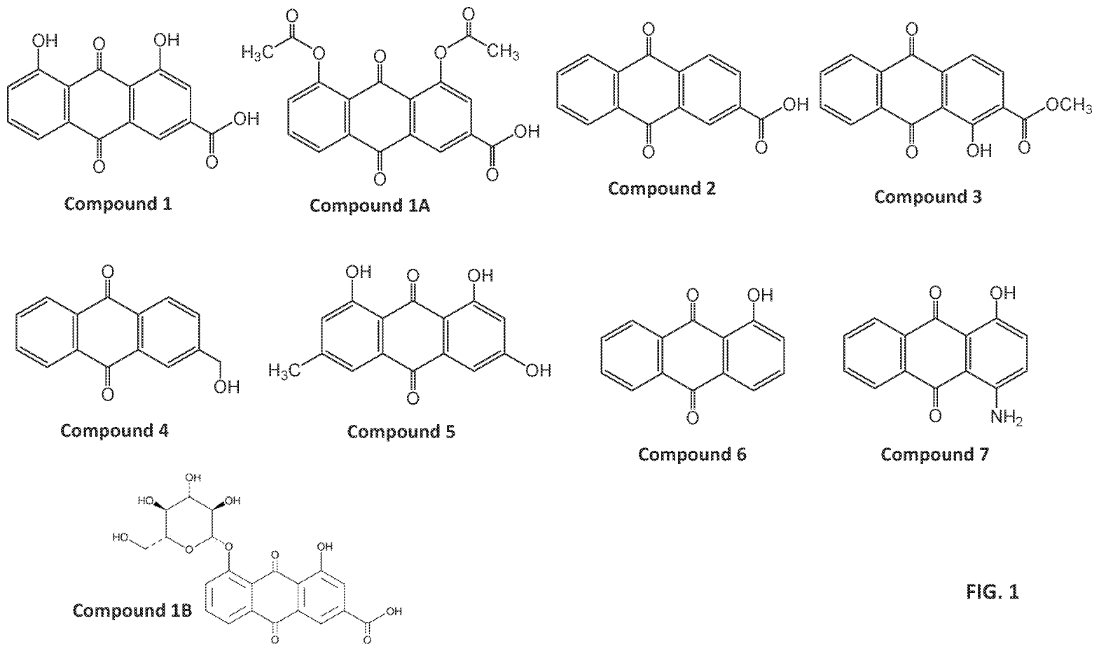

Exemplary compounds of Formula I and/or Formula Ia as described herein are presented in FIG. 1.

According to some of any of the embodiments described herein, the anthraquinone compound of Formula I or Formula Ia is an isolated and/or purified compound. According to some embodiments, the anthraquinone compound does not form a part of plant extract or any other plant-derived mixture of components. According to some embodiments, the anthraquinone compound is an isolated and/or purified compound that is derived from a plant, for example, is isolated and/or purified from a plant extract.

### Compositions:

Any of the anthraquinone compounds as described herein can form a part of a composition which further comprises a carrier. When used in agricultural applications, as described in further detail hereinafter, the carrier is preferably an agriculturally acceptable carrier.

According to an aspect of some embodiments of the present invention, there is provided a composition that comprises a compound represented by Formula I, as described herein in any of the respective embodiments and any combination thereof, and a carrier, preferably an agriculturally acceptable carrier as described herein in any of the respective embodiments.

According to some of any of the embodiments described herein, the composition is for use in agricultural applications, for example, for crop protection as described in further detail hereinunder, for example, as a pesticidal composition and/or a herbicidal composition.

According to some of any of the embodiments described herein, the composition is formulated for foliar application, and according to some of these embodiments, it is a liquid composition, which comprises a liquid carrier. According to some of any of the embodiments described herein, the composition is a form of a solution, a dispersion, a suspension, a foam, an aerosol, or an emulsion. According to some of any of the embodiments described herein, the composition is a sprayable composition.

According to some of any of the embodiments described herein, the carrier is an aqueous carrier, or an aqueous-based carrier, which comprises water or an aqueous solution, optionally in combination with other ingredients, including organic solvents, and other, organic and/or inorganic ingredients, such as additives, adjuvants, emulsifiers, etc., as described in further detail hereinunder.

The compositions of the present embodiments can be produced in known manners, for example by mixing the active compounds with the carrier, optionally with the use of other components (additives), as described herein.

As described in the Examples section that follows, the present inventors have uncovered during laborious experimentation that by manipulating the nature of the carrier and of optional additives, at least the herbicidal activity of the anthraquinone compounds can be manipulated.

According to some of any of the embodiments described herein, the composition comprises an aqueous-based carrier in a form of an emulsion, and the carrier comprises water or an aqueous solution and an organic solvent. According to some of these embodiments, the composition further comprises one or more emulsifier(s).

The organic solvent is preferably selected so as to efficiently solubilize the anthraquinone compound without adversely affecting its activity and/or the composition's performance. Further preferably, the organic solvent is selected in accordance with local regulation requirements. The organic solvent is also referred to herein as a “solubilizer”.

According to some embodiments, the carrier comprises a mixture of organic solvents, which is also referred to herein as an organic solvent system, and at least one of the organic solvents is a water-miscible organic solvent.

The phrase “water-miscible organic solvent”, as used herein, refers to organic solvents that are soluble and/or dispersible in water (e.g., when mixed at room temperature at equal volumes). Several factors inherent in the structure of the solvent molecules can affect the miscibility of organic solvents in water, such as for example, the length of the carbon chain and the type of functional groups therein.

Exemplary, non-limiting, organic water-miscible solvents that are usable in the context of the present embodiments include polar and/or aprotic solvents, such as, for example, dimethyl formamide, dimethylsulfoxide, pyrrolidones, furans, ketones, pyridines, pyrimidines, etc.

According to exemplary embodiments, the organic solvent comprises DMSO.

According to preferred exemplary embodiments, the organic solvent comprises a ketone, for example, acetone, methyl ethyl ketone, methyl isobutyl ketone, cyclohexanone, acetophenone, and the like. In exemplary embodiments, the organic solvent comprises acetophenone.

According to preferred exemplary embodiments, the organic solvent comprises a pyrrolidone, for example, N-methyl pyrrolidone.

According to some exemplary embodiments, the organic solvent comprises a mixture of a ketone (e.g., acetophenone) and a pyrrolidone (e.g., N-methyl pyrrolidone). According to some of these embodiments, a weight ratio of the ketone or pyrrolidone ranges from about 6:1 to 2:1, or from 5:1 to 2:1, or from 4:1 to 3:1.

According to some of any of the embodiments described herein in the context of a composition in a form of an emulsion, an amount of the organic solvent or the organic solvent system as described herein (e.g., a total amount of acetophenone and N-methyl pyrrolidone) ranges from about 1% to about 20%, or from about 5% to about 20%, or from about 5% to about 15%, or from about 5% to about 10%, or from about 8% to about 15%, by weight of the total weight of the composition. The amount of the organic solvent can be determined by determining a minimal amount required to efficiently solubilize the anthraquinone compound, and depends, inter alia, on the amount of the anthraquinone compound in the composition.

Herein, the organic solvent or organic solvent system is also referred to herein as a solubilizer, which is aimed at facilitating the formulation of the anthraquinone compounds in an aqueous-based formulation (which comprises an aqueous-based carrier).

According to some of any of the embodiments described herein for a composition in a form of an emulsion, the composition further comprises an emulsifier (e.g., one or more emulsifiers or an emulsifier system), which is added for facilitating and/or stabilizing the emulsion.

As used herein, the phrase “emulsifier” describes a chemical substance that acts as a stabilizer for emulsions, preventing liquids that are immiscible with one another from separating, typically by increasing the kinetic stability of the emulsion by e.g., lowering the interfacial tension between the liquids.

According to some of these embodiments, the composition comprises one or more emulsifiers, or an emulsifier system which comprises two or more emulsifiers.

While any emulsifier is usable in the context of the present embodiments, preferred emulsifiers include, but not limited to, sulfonate emulsifiers such as an alkyl sulfonate, an aryl sulfonate and/or alkaryl sulfonate; and ethoxylated oils (e.g., ethoxylated mineral oils).

According to some of any of the embodiments described herein, the composition comprises one or more sulfonate emulsifiers, including an alkyl sulfonate, an aryl sulfonate and/or alkaryl sulfonate. According to some of these embodiments, the composition comprises an aryl sulfonate emulsifier, for example, calcium dodecylbenzene sulfonate (abbreviated herein as Ca-LAS) such as marketed under the tradename Rhodacal® 60be. According to some of these embodiments, the composition comprises a sulfonate emulsifier as described herein in an amount that ranges from 0.01 to 10, or from 0.01 to 5, or from 0.01 to 1, or from 0.1 to 1, or about 0.5, % by weight, of the total weight of the composition, including any intermediate values and subranges therebetween.

According to some of any of the embodiments described herein, the composition comprises one or more ethoxylated oil emulsifiers, preferably ethoxylated mineral oils. According to some of these embodiments, the composition comprises an ethoxylated castor oil (abbreviated herewith as ECO), such as marketed under the tradename Kolliphor® RH 40. According to some of these embodiments, the composition comprises an ethoxylated oil emulsifier as described herein in an amount that ranges from 0.01 to 10, or from 0.01 to 5, or from 0.01 to 1, or from 0.1 to 1, or about 0.5, % by weight, of the total weight of the composition, including any intermediate values and subranges therebetween.

According to some of any of the embodiments described herein, the composition comprises an emulsifier system that comprises two or more emulsifiers, and according to some of these embodiments, the composition comprises two or more of sulfonate emulsifiers such as an alkyl sulfonate, an aryl sulfonate and/or alkaryl sulfonate; ethoxylated oils (e.g., ethoxylated mineral oils); and/or polyether-modified polysiloxanes, as described herein in any of the respective embodiments.

According to some of any of the embodiments described herein, a total amount of the one or more emulsifiers in the composition ranges from 0.01 to 10, or from 0.01 to 5, or from 0.01 to 2, or from 0.1 to 2, or from 0.5 to 2, or from 0.5 to 1.5, % by weight, of the total weight of the composition, including any intermediate values and subranges therebetween.

According to some of any of the embodiments described herein, when the composition comprises two or more emulsifiers, a weight ratio between at least two emulsifiers can range from 1:1 to 1:0.05, or from 1:1 to 1:0.08, or from 1:1 to 1:0.09, or from 1:1 to 1:0.1, or from 1:1 to 1:0.5, or from 1:1 to 1:0.9, or from 1:0.5 to 1:0.05, of from 1:0.5 to 1:0.08, or from 1:0.5 to 1:0.09, or from 1:0.5 to 1:0.1, or from 1:0.5 to 1:0.9, including any intermediate values and subranges therebetween.

In exemplary embodiments, the composition comprises emulsifiers such as ECO and Ca-LAS as described herein at a weight ratio that ranges from 1:1 to 1:0.05, or from 1:1 to 1:0.08, or from 1:1 to 1:0.09, or from 1:1 to 1:0.1, or from 1:1 to 1:0.5, or from 1:1 to 1:0.9, or from 1:0.5 to 1:0.05, or from 1:0.5 to 1:0.08, or from 1:0.5 to 1:0.09, or from 1:0.5 to 1:0.1, or from 1:0.5 to 1:0.9, including any intermediate values and subranges therebetween.

According to some of any of the embodiments described herein, the composition is an aqueous composition that comprises:
an aryl sulfonate emulsifier, for example, calcium dodecylbanzene sulfonate (abbreviated herein as Ca-LAS) such as marketed under the tradename Rhodacal® 60be, in an amount of from 0.1 to 1, or of about 0.5, % by weight, of the total weight of the composition; and
an ethoxylated mineral oil, for example, an ethoxylated castor oil (abbreviated herewith as ECO), such as marketed under the tradename Kolliphor® RH 40, in an amount of from 0.1 to 1, or of about 0.5, % by weight, of the total weight of the composition, including any intermediate values and subranges therebetween.

According to some of any of the embodiments described herein, the composition is an aqueous composition that comprises:
from about 1 to about 20, or from about 5 to about 15, % by weight of an organic solvent as described herein in any of the respective embodiments, for example, a mixture of acetophenone and N-methyl-pyrrolidone as described herein;
an aryl sulfonate emulsifier, for example, calcium dodecylbanzene sulfonate (abbreviated herein as Ca-LAS) such as marketed under the tradename Rhodacal® 60be, in an amount of from 0.1 to 1, or of about 0.5, % by weight, of the total weight of the composition; and
an ethoxylated mineral oil, for example, an ethoxylated castor oil (abbreviated herewith as ECO), such as marketed under the tradename Kolliphor® RH 40, in an amount of from 0.1 to 1, or of about 0.5, % by weight, of the total weight of the composition, including any intermediate values and subranges therebetween.

According an aspect of some embodiments of the present invention there is provided a composition that comprises a compound of Formula I as described herein in any of the respective embodiments and any combination, and an agriculturally acceptable aqueous-based carrier, with the carrier comprising:
from about 1 to about 20, or from about 5 to about 15, % by weight of an organic solvent as described herein in any of the respective embodiments, for example, a mixture of acetophenone and N-methyl-pyrrolidone as described herein;
an aryl sulfonate emulsifier, for example, calcium dodecylbanzene sulfonate (abbreviated herein as Ca-LAS) such as marketed under the tradename Rhodacal® 60be, in an amount of from 0.1 to 1, or of about 0.5, % by weight, of the total weight of the composition; and
an ethoxylated mineral oil, for example, an ethoxylated castor oil (abbreviated herewith as ECO), such as marketed under the tradename Kolliphor® RH 40, in an amount of from 0.1 to 1, or of about 0.5, % by weight, of the total weight of the composition, including any intermediate values and subranges therebetween.

According to an aspect of some embodiments of the present invention there is provided a composition that comprises a compound referred to herein as Compound 4, and an agriculturally acceptable carrier, the composition being in a form of an emulsion. According to some of these embodiments, the carrier comprises water, an organic solvent or solvent system as described herein in any of the respective embodiments and any combination thereof, and an emulsifier or an emulsifier system as described herein in any of the respective embodiments and any combination thereof.

According to some embodiments of this aspect of the present invention, the aqueous-based carrier comprises:
from about 1 to about 20, or from about 5 to about 15, % by weight of an organic solvent as described herein in any of the respective embodiments, for example, a mixture of acetophenone and N-methyl-pyrrolidone as described herein;
an aryl sulfonate emulsifier, for example, calcium dodecylbanzene sulfonate (abbreviated herein as Ca-LAS) such as marketed under the tradename Rhodacal® 60be, in an amount of from 0.1 to 1, or of about 0.5, % by weight, of the total weight of the composition; and
an ethoxylated mineral oil, for example, an ethoxylated castor oil (abbreviated herewith as ECO), such as marketed under the tradename Kolliphor® RH 40, in an amount of from 0.1 to 1, or of about 0.5, % by weight, of the total weight of the composition, including any intermediate values and subranges therebetween.

According to an aspect of some embodiments of the present invention there is provided a composition that comprises a compound referred to herein as Compound 6, and an agriculturally acceptable carrier, the composition being in a form of an emulsion. According to some of these embodiments, the carrier comprises water, an organic solvent or solvent system as described herein in any of the respective embodiments and any combination thereof, and an emulsifier or an emulsifier system as described herein in any of the respective embodiments and any combination thereof.

According to some embodiments of this aspect of the present invention, the aqueous-based carrier comprises:
from about 1 to about 20, or from about 5 to about 15, % by weight of an organic solvent as described herein in any of the respective embodiments, for example, a mixture of acetophenone and N-methyl-pyrrolidone as described herein;
an aryl sulfonate emulsifier, for example, calcium dodecylbanzene sulfonate (abbreviated herein as Ca-LAS) such as marketed under the tradename Rhodacal® 60be, in an amount of from 0.1 to 1, or of about 0.5, % by weight, of the total weight of the composition; and
an ethoxylated mineral oil, for example, an ethoxylated castor oil (abbreviated herewith as ECO), such as marketed under the tradename Kolliphor® RH 40, in an amount of from 0.1 to 1, or of about 0.5, % by weight, of the total weight of the composition, including any intermediate values and subranges therebetween.

According to an aspect of some embodiments of the present invention there is provided a composition that comprises a compound referred to herein as Compound 5, and an agriculturally acceptable carrier, the composition being in a form of an emulsion. According to some of these embodiments, the carrier comprises water, an organic solvent or solvent system as described herein in any of the respective embodiments and any combination thereof, and an emulsifier or an emulsifier system as described herein in any of the respective embodiments and any combination thereof.

According to some embodiments of this aspect of the present invention, the aqueous-based carrier comprises:
from about 1 to about 20, or from about 5 to about 15, % by weight of an organic solvent as described herein in any of the respective embodiments, for example, a mixture of acetophenone and N-methyl-pyrrolidone as described herein;
an aryl sulfonate emulsifier, for example, calcium dodecylbanzene sulfonate (abbreviated herein as Ca-LAS) such as marketed under the tradename Rhodacal® 60be, in an amount of from 0.1 to 1, or of about 0.5, % by weight, of the total weight of the composition; and
an ethoxylated mineral oil, for example, an ethoxylated castor oil (abbreviated herewith as ECO), such as marketed under the tradename Kolliphor® RH 40, in an amount of from 0.1 to 1, or of about 0.5, % by weight, of the total weight of the composition, including any intermediate values and subranges therebetween.

According to an aspect of some embodiments of the present invention there is provided a composition that comprises a compound referred to herein as Compound 7, and an agriculturally acceptable carrier, the composition being in a form of an emulsion. According to some of these embodiments, the carrier comprises water, an organic solvent or solvent system as described herein in any of the respective embodiments and any combination thereof, and an emulsifier or an emulsifier system as described herein in any of the respective embodiments and any combination thereof.

According to some embodiments of this aspect of the present invention, the aqueous-based carrier comprises:
from about 1 to about 20, or from about 5 to about 15, % by weight of an organic solvent as described herein in any of the respective embodiments, for example, a mixture of acetophenone and N-methyl-pyrrolidone as described herein;
an aryl sulfonate emulsifier, for example, calcium dodecylbanzene sulfonate (abbreviated herein as Ca-LAS) such as marketed under the tradename Rhodacal® 60be, in an amount of from 0.1 to 1, or of about 0.5, % by weight, of the total weight of the composition; and
an ethoxylated mineral oil, for example, an ethoxylated castor oil (abbreviated herewith as ECO), such as marketed under the tradename Kolliphor® RH 40, in an amount of from 0.1 to 1, or of about 0.5, % by weight, of the total weight of the composition, including any intermediate values and subranges therebetween.

Additional compositions according to the present embodiments comprise a compound represented by Formula Ia as described herein in any of the respective embodiments and any combination thereof and an agriculturally acceptable carrier, which is in a form of an emulsion and comprises an organic solvent or organic solvent system and an emulsifier or an emulsifier system as described herein in any of the respective embodiments and any combination thereof.

According to alternative embodiments of the present invention, compounds of Formula Ia as described herein, or compounds of Formula I as described herein, in which one or more of R₁, R₂, R₃ and R₈, is —C(═O)—OR₁₀, are formulated in a form of an aqueous solution, in the presence of an alkaline substance. Such compounds feature a carboxylic acid substituent (when R₁₀ is hydrogen) which, in the presence of an alkaline substance, are ionized or converted into a salt, and hence are dissolvable.

According an aspect of some embodiments of the present invention, there is provided a composition that comprises a compound of Formula Ia as described herein in any of the respective embodiments and any combination thereof, and an agriculturally acceptable carrier, wherein the carrier comprises water and an alkaline substance as described herein.

According to some embodiments of this aspect of the present invention, an amount of the alkaline substance is around a stoichiometric amount with respect to the anthraquinone compound, or with respect to the carboxylic groups of the anthraquinone compound, such that a molar ratio of the alkaline substance or buffer to the anthraquinone compound ranges, for example, from 3:1 to 1:1, or from 2:1 to 1:1, including any intermediate values and subranges therebetween. In exemplary embodiments, the alkaline substance is in an amount that provides a concentration of from 0.1 to 50, or from 0.1 to 30, or from 0.1 to 20, or from 0.5 to 20, or from 0.5 to 15, mM, in the composition.

According to some of any of these embodiments, the alkaline substance is such that features pH in a range of from 7.5 to 10.5, or from 7.5 to 9.5, or from 7.5 to 9, or from 7.5 to 8.5, or from 8 to 9, including any intermediate values and subranges therebetween.

Exemplary alkaline substances that are suitable for use in the context of these embodiments include, but are not limited to, alkali metal hydroxides such as potassium hydroxide, sodium hydroxide and the like, ammonium salts, ammonium hydroxides, and primary, secondary or tertiary amines. The alkaline substance can form a part of an alkaline buffer that features a desired pH as described herein, and is present in the buffer in an amount that provides a mol ratio to the anthraquinone compound and/or a concentration as described herein in any of the respective embodiments.

Non-limiting examples of an alkaline substance include potassium hydroxide (for example, in a concentration that ranges from 0.5 to 10, or from 0.8 to 8, mM); ammonium hydroxide (for example, in a concentration that ranges from 0.5 to 10, or from 0.5 to 8, mM); mono-isopropyl amine (MIPA) (for example, in a concentration that ranges from 1 to 20, or from 5 to 15, mM); and Tris buffer (for example, in a concentration that ranges from 10 to 100, or from 20 to 80, mM).

### Adjuvants:

According to some of any of the embodiments described herein, any of the compositions as described herein further comprises one or more adjuvants.

The term “adjuvant” as used herein in the context of the present embodiments, describes a substance that modifies the herbicidal activity of a composition comprising same. In some embodiments, the composition is a herbicidal composition or a composition for foliar application or for post-emergence application, as described herein, and an adjuvant in the context of these embodiments is a substance that facilitates movement of the herbicide from the leaf surface to the interior of the cell and/or improves the herbicide absorption by the plant (e.g., weed) to be treated and/or generally improves herbicidal activity.

Currently known adjuvants for post-emergence application of herbicidal compositions are typically categorized as surfactants, penetration enhancers, wetting agents, crop oil concentrates and ammonium fertilizers.

According to some embodiments of the present invention, the composition further comprises one or more adjuvants, and at least one of the adjuvant(s) is a surfactant, for example, a surfactant (also referred to herein as a “surface active agent”) known to improve herbicidal activity in post-emergence applications.

Any adjuvant or a mixture of adjuvants or any surfactant or a mixture of surfactants are usable in the context of these embodiments, including non-ionic, anionic, cationic and zwitterionic surfactants.

Representative examples of non-ionic surfactants include, without limitation, polyethoxylated alkyl phenols, polyethoxylated glyceryl esters, and polyethoxylated organic ethers derived from fatty acids, including, but not limited to, polysorbate 60, ethoxylated sorbitan stearate, ethoxylated sorbitan palmitate, ethoxylated sorbitan oleate, fatty alcohol ethoxylates, fatty acid esters, polyoxyethylene (POE) alkyl ethers, branched oxoalcohol C11 with 5 mol EO, and any combinations thereof. Additional examples of nonionic surfactants include, but are not limited to, ethoxylated castor oil, narrow-range ethoxylate, octaethylene glycol monododecyl ether, pentaethylene glycol monododecyl ether, nonoxynols, triton X-100, polyethoxylated tallow amine, cocamide monoethanolamine, cocamide diethanolamine, poloxamers, alkoxylated alcohol-phosphate esters, glycerol monostearate, glycerol monolaurate, sorbitan monolaurate, sorbitan monostearate, sorbitan tristearate, surfactants of Tween® family (e.g., Tween® 20, 40, 60, and 80), decyl glucoside, lauryl glucoside, octyl glucoside, lauryldimethylamine oxide, dimethyl sulfoxide, phosphine oxide, and others. In some embodiments, the non-ionic surfactant is an ethoxylated castor oil.

Examples of anionic surfactants include, but are not limited to, alkyl phosphate, alkyl carboxylate, alkyl sulfate, and alkyl sulfonate type surfactants, including, for example, free organic (e.g., fatty) acids, organic phosphate esters, α-olefinsulfonate and its salts, and alkali salts of sulfosuccinic acid half-esters (e.g., dioctyl ester of sodium sulfosuccinic acid).

Some exemplary anionic surfactants include, but are not limited to, Alginic acid sodium salt, ALKANOL® 189-S, Capstone® FS-66, Glycolic acid ethoxylate 4-tert-butylphenyl ether, Glycolic acid ethoxylate lauryl ether, Glycolic acid ethoxylate lauryl ether, Glycolic acid ethoxylate lauryl ether, Glycolic acid ethoxylate 4-nonylphenyl ether, Glycolic acid ethoxylate oleyl ether, Poly(ethylene glycol) 4-nonylphenyl 3-sulfopropyl ether potassium salt, Zonyl® FSA fluorosurfactant 25 wt. % Li carboxylate salt in water:isopropyl alcohol (1:1), and Zonyl® UR fluorosurfactant. Additional examples of anionic surfactants include, but are not limited to, alkylbenzenesulfonate, ammonium lauryl sulfate, sodium lauryl sulfate (sodium dodecyl sulfate, SLS, or SDS), sodium laureth sulfate (sodium lauryl ether sulfate or SLES), sodium myreth sulfate, dioctyl sodium sulfosuccinate (Docusate), perfluorooctanesulfonate (PFOS), perfluorobutanesulfonate, alkyl-aryl ether phosphates, alkyl ether phosphates, sodium stearate, sodium lauroyl sarcosinate, perfluorononanoate, and perfluorooctanoate (PFOA or PFO). In some embodiments, the anionic surfactant is a linear alkylbenzenesulfonate.

Examples of cationic surfactants include, but are not limited to, long-chained quaternized ammonium compounds, for example, behenyl trimethyl ammonium chloride, benzyl tetradecyl-dimethyl-ammonium chloride, cetyl pridinium chloride, cetyl trimethyl ammonium chloride, dimethyl dihydrogenated-tallow ammonium chloride, dimethyl stearyl ammonium chloride, dimethyl-stearyl benzyl ammonium chloride, lauryl dimethylbenzyl ammonium chloride, lauryl-trimethyl-ammonium chloride, stearyl trimethyl ammonium chloride, trimethylacetyl-ammonium bromide, and tris-(oligooxy-ethyl) alkylammonium phosphate.

Examples of zwitterionic surfactants include betaines (such as fatty acid-amidoalkylbetaine and sulfobetaine) and long-chained alkylamino acids (such as cocoaminoacetate, cocoamino-propionate, sodium cocoamphopropionate and sodium cocoamphoacetate).

According to some of any of the embodiments described herein, the surfactant is non-phytotoxic.

According to some embodiments, the composition comprises as an adjuvant at least one surfactant which is a non-ionic surfactant, for example, a polyethoxylated surfactant such as a polyethoxylated sorbitan, an ethoxylated tallow amine, tristryrilphenol ethoxylated, and like compounds.

According to some of any of the embodiments described herein, the surfactant is an anionic surfactant, for example, a fatty ether sulfate.

According to some of any of the embodiments described herein, the surfactant is polyether-modified polysiloxane. According to some of these embodiments, the composition comprises a polyether-modified polysiloxane such as marketed under the tradename Break-Thru, for example, Break-Thru® S 200, Break-Thru® S 240, Break-Thru® S 279 or Break-Thru® S 301. According to some of these embodiments, the composition comprises a polysiloxane surfactant as described herein in an amount that ranges from 0.01 to 1, or from 0.01 to 0.5, or from 0.01 to 0.1, or about 0.05, % by weight, of the total weight of the composition, including any intermediate values and subranges therebetween.

According to some embodiments, the composition comprises as an adjuvant at least one surfactant which is an ethoxylated sorbitan mono-ester surfactant, also known as “polysorbate”, for example those available under the trademark “Tween®”.

According to other embodiments of the present invention, the adjuvant is a crop oil concentrate, for example, methylated rapeseed oil such as marketed under the tradename Agnique®.

According to other embodiments of the present invention, the adjuvant is or comprises fatty acid esters and/or alkoxylated alcohols-phosphate esters, such as marketed under the tradename DASH®.

Exemplary adjuvants that are usable in the context of the present embodiments are presented in Tables 1A, 1B and 3.

According to some of any of the embodiments described herein, the composition comprises one or more adjuvants, and the total adjuvant concentration ranges from 0.1 to 10, or from 0.1 to 5, or from 0.2 to 5, or from 0.1 to 1, or from 1 to 5%, by weight of the total weight of the composition.

The amount of the adjuvants depends in part of the type of the selected adjuvant.

According to exemplary embodiments of the present invention, the composition comprises at least one adjuvant which is an ethoxylated sorbitan mono-ester surfactant, preferably a highly ethoxylated such surfactant, for example, those marketed under the tradenames Tween®20, Tween®40, Tween®60 and/or Tween®80. According to some of these embodiments, an amount of this surfactant is at least 0.5%, or at least 1%, and can be, for example, in a range of from about 0.5 to about 5, or from about 1 to about 5, %, by weight of the total weight of the composition, including any intermediate values and subranges therebetween.

According to some of any of the embodiments described, the composition comprises a polyether-modified polysiloxane emulsifier such as marketed under the tradename Break-Thru, as described herein, in an amount that ranges from 0.01 to 0.1, or of about 0.05, % by weight, of the total weight of the composition, including any intermediate values and subranges therebetween.

According to some of any of the embodiments described, a composition that comprises an organic solvent and an emulsifier or an emulsifier system, as described herein in any of the respective embodiments, further comprises a polyether-modified polysiloxane emulsifier such as marketed under the tradename Break-Thru, as described herein, in an amount that ranges from 0.01 to 0.1, or of about 0.05, % by weight, of the total weight of the composition, including any intermediate values and subranges therebetween.

### Additives:

Any of the compositions as described herein may further comprise, in addition to the carrier, the emulsifier, if present, and an adjuvant, if present, one or more additives which are typically aimed at improving the physical and/or chemical properties/consistency of the composition.

Exemplary additives include, but are not limited to, compatibility agents, buffering agents, antifoam agents, drift control agents, sticking agents (e.g., adherents, tackifiers), spreading agents, and any combination thereof.

In some embodiments, a total amount of the one or more additives in the composition can range from 0.01 to 10, for from 0.01 to 1, or from 0.01 to 0.1, or from 0.1 to 0.5, or from 0.5 to 1, or from 0.1 to 0.3, or from 0.3 to 0.5, or from 0.5 to 0.7, or from 0.7 to 1, from 1 to 2, or from 1 to 5, % by weight of the total weight of the formulation.

Non-limiting examples of adherents include alginate, a gum, a starch, a lecithin, formononetin, polyvinyl alcohol, alkali formononetinate, hesperetin, polyvinyl acetate, a cephalin, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Tricthylene glycol, Vinyl Acetate, Gellan Gum, Polystyrene, Polyvinyl, Carboxymethyl cellulose, Gum Ghatti, and a polyoxyethylene-polyoxybutylene block copolymer.

Non-limiting examples of suitable dispersing agents include lignin sulfite waste liquors and methylcellulose, carboxymethyl cellulose Supragil, Ufoxan, a copolymer of benzylmethacrylate, acrylic acid and 2-acrylamido-2-methyl propane sulfonic acid, and other ionic and non-ionic polymeric dispersants known in the art.

### Exemplary Compositions:

According to exemplary embodiments of the present invention, a composition as described herein in any of the embodiments and any combination thereof is a sprayable composition.

According to exemplary embodiments of the present invention, a composition as described herein in any of the embodiments and any combination thereof is formulated or configured for post-emergence application.

According to exemplary embodiments of the present invention, a composition as described herein in any of the embodiments and any combination thereof is formulated or configured for foliar application.

According to exemplary embodiments of the present invention, a composition as described herein in any of the embodiments and any combination thereof is formulated or configured for post-emergence foliar application.

According to exemplary embodiments of the present invention, a composition as described herein in any of the embodiments and any combination thereof is a sprayable composition for post-emergence foliar application.

According to some embodiments of the present invention, the composition comprises a compound of Formula Ia as described herein in any of the respective embodiments and an aqueous carrier. According to some of these embodiments, the carrier comprises an alkaline substance, as described herein in any of the respective embodiments, and one or more adjuvants, as described herein in any of the respective embodiments. According to some of these embodiments, the carrier is an aqueous carrier and further comprises: an alkaline substance as described herein in a mol ratio of from 2:1 to 1:1 relative to the compound of Formula Ia; and at least one adjuvant as described herein that comprises a non-ionic surfactant in an amount of from 0.1 to 5% by weight of the total weight of the composition.

According to some embodiments of the present invention, the composition comprises a compound of Formula I as described herein in any of the respective embodiments, for example, Compounds 4, 5, 6, or 7, and an aqueous carrier which further comprises an organic solvent, and is in a form of an emulsion, as described herein in any of the respective embodiments. According to some of these embodiments, the carrier comprises an organic solvent, at least one emulsifier and at least one adjuvant, the organic solvent comprises at least one polar aprotic organic solvent; an amount of said organic solvent ranges from about 5 to about 20, or from about 5 to about 15, % by weight, of the total weight of the composition; an amount of said at least one emulsifier ranges from 0.1 to 2% by weight of the total weight of the composition; and an amount of said at least one adjuvant ranges from about 0.1% to about 10%, by weight of the total weight of the composition.

According to some of any of the embodiments described herein, the amount of the anthraquinone compound in the composition is a herbicidal effective amount or a pesticidal effective amount, which is sufficient to effect (reduce, inhibit, arrest) the growth of the herb or pest to be treated and to protect the harboring plant. According to some of these embodiments, the effective amount is sufficient for controlling or preventing growth of a weed, as described in further detail hereinafter.

According to some of any of the embodiments described herein, the composition is, or is identified, for use in controlling or preventing growth of an herb (an unwanted herb such as weed) or of a pest, as described herein.

According to some of any of the embodiments described herein, the composition is, or is identified, for use in controlling a growth of a plant or in crop protection, by controlling the growth of unwanted herb or pest in or in the vicinity of the plant, as described herein.

According to some of any of the embodiments described herein, the composition is packaged in a kit, and the kit is identified for uses as described herein. In some of these embodiments, the kit further comprises instructions how to use the composition. In some of these embodiments, the anthraquinone compounds and the carrier, and the additional optional components (e.g., emulsifier, adjuvant, additive) are packaged together within the kit. Alternatively, the anthraquinone compound is packaged individually in the kit, while the carrier and the additional optional components (e.g., emulsifier, adjuvant, additive) are packaged separately from the anthraquinone compound. In such embodiments, the kit may further comprise instructions to mix the anthraquinone compound with the carrier prior to use, in an effective amount as described herein. Further alternatively, the kit may be such that a concentrated, dilutable, composition that comprises the anthraquinone compound, the carrier and the optional additional ingredients, is packaged therein, and a diluting medium is separately packaged in the kit, or the kit comprises instructions to add a diluting medium to the concentrated composition. The diluting medium can be the carrier as described herein in any of the respective embodiments, or water, or an organic solvent, or a mixture of water and an organic solvent, and optionally one or more of the additive, adjuvant and/or emulsifier, as described herein.

The kit may further include means for mixing components of the composition or for diluting a concentration composition, as needed.

The kit may further comprise means for dispensing the composition.

The amount of the anthraquinone compound is determined using methods known in the art, for example, in growth chamber assays or greenhouse assays such as described in the Examples section that follows.

In exemplary embodiments, the amount of the anthraquinone compound in the composition ranges from 0.1 gram/liter to 20 grams/liter, or from 0.1 gram/liter to 10 grams/liter, or from 0.1 gram/liter to 5 grams/liter, or from 0.2 gram/liter to 2 grams/liter, including any intermediate values and subranges therebetween.

### Uses:

According to some of any of the embodiments described herein, the anthraquinone as described herein or the composition comprising same as described herein, is for use in controlling a growth of a plant substance or in a method of controlling a growth of a plant substrate.

In some of any of the embodiments described herein, the method is for controlling herbs (weeds) and/or pests in, on or in the vicinity of a plant substrate as described herein, for example, by reducing the numbers of herbs and/or pests in or on soil or other plant medium and to prevent infection; by reducing the numbers of herbs and/or pests on plants or plant material such as roots, fruits and seeds; by reducing the damaging effect of herbs and/or pests on the plant by, for example, killing, injuring or inhibiting the growth and/or activity of the herb and/or pest.

Plant pests include, for example, insects, arachnids, helminthes, nematodes, molluscs, bacteria, fungi, mites, oomycytes and protozoa. The method described herein can be used to control, kill, injure, paralyze, or reduce the activity of one or more of any of these pests in their egg, larvae, adult, juvenile, or desiccated forms.

Nematodes that damage plants include, for example, Meloidogyne spp. (root-knot), Heterodera spp., Globodera spp., Pratylenchus spp., Helicotylenchus spp., Radopholus similis, Ditylenchus dipsaci, Rotylenchulus reniformis, Xiphinema spp., Aphelenchoides spp. and Belonolaimus longicaudatus. Among the crops with the greatest estimated losses due to nematode parasitism are corn, cotton, cucurbits, leguminous vegetables, peanut, solanaccous vegetables, soybean, sugarcane, and tobacco.

Insects cause two types of damage to plants. The first type of damage is direct injury done to the plant by the insect, which cats leaves or burrows into plant tissues. There are a multitude of insect species of this type, both larvae and adults, among orthopterans, homopterans, heteropterans, coleopterans, lepidopterans, and dipterans. The second type of damage is indirect damage where the insect itself does little or no harm but transmits a bacterial, viral, or fungal infection to a plant. Insects that cause these two types of damage to plants include, for example, Coleoptera (beetles, weevils), Cerambycidae (long-horned beetles), Chrysomelidae (leaf beetles), Coccinellidac (lady beetles), Curculionidae (snout beetles, weevils, billbugs), Elateridae (click beetles), Meloidae (blister beetles), Scarabacidae (scarab beetles), Tenebrionidae (darkling beetles), Diptera (flies), Anthomyiidae (root maggot flies), Cecidomyiidae (midges), Hemiptera suborder heteroptera (true bugs), Lygacidae (seed bugs, chinch bugs), Miridae (plant bugs, lygus bugs), Pentatomidae (stink bugs), Hemiptera suborder homoptera (aphids, whiteflies, leafhoppers, scales), Aleyrodidae (whiteflies), Aphididae (aphids), Cercopidae (spittlebugs), Cicadellidae (leafhoppers), Membracidae (treehoppers), Lepidoptera (moths, butterflies), Noctuidae (cutworm moths), Pyralidae (snout and grass moths), Sphingidae (sphinx moths), Orthoptera (grasshoppers and crickets), Acrididae (short-horned grasshoppers), Gryllidae (crickets), Gryllotalpidae (mole crickets), Thysanoptera (thrips), Thripidae (common thrips), Acarina (mites), Tetranychidae (spider mites).

Arachnids such as earth mites (Penthaleidae), thread-footed mites (Tarsonemidae) and gall and rust mites (Eriophyoidea) can also cause damage to plants.

Molluscs, including those in the gastropod class and those in the subclass pulmonata, can cause damage to plants. Molluscs also include, for example, snails and slugs, such as Ampullariidae spp.; Arion spp. (A. ater, A. circumscriptus, A. hortensis, A. rufus); Bradybaenidae spp. (Bradybaena fruticum); Cepaca spp. (C. hortensis, C. nemoralis); Ochlodina; Deroceras spp. (D. agrestis, D. empiricorum, D. laeve, D. reticulatum); Discus spp. (D. rotundatus); Euomphalia spp.; Galba spp. (G. trunculata); Helicelia spp. (H. itala, H. obvia); Helicidae spp. (Helicigona arbustorum); Helicodiscus spp.; Helix spp. (H. aperta); Limax spp. (L. cinerconiger, L. flavus, L. marginatus, L. maximus, L. tenellus); Lymnaca spp.; Milax spp. (M. gagates, M. marginatus, M. sowerbyi); Opcas spp.; Pomacea spp. (P. canaticulata); Vallonia spp. and Zanitoides.

Herbs known to damage plants include, for example, Lolium Rigidum, Amaramthus palmeri, Abutilon theopratsi, Sorghum halepense, Conyza Canadensis, Setaria verticillata, Capsella pastoris, and Cyperus rotundus. Additional herbs include, for example, Mimosa pigra, salvinia, hyptis, senna, noogoora, burr, Jatropha gossypifolia, Parkinsonia aculeate, Chromolaena odorata, Cryptoslegia grandiflora, Anndropogon gayanus. Additional herbs are described hereinbelow.

According to some of any of the embodiments described herein, controlling the growth of the plant is effected by contacting the plant substrate or its vicinity with a composition as described herein.

According to some of any of the embodiments described herein, when controlling the growth of the plant substrate is by killing, injuring or inhibiting the growth and/or activity of an undesired herb in the vicinity of the plant, the method is effected by contacting the herb with the composition as described herein.

According to some of any of the embodiments described herein, the contacting is effected by applying the composition to a plant's foliage or to an herb's foliage (foliar application).

In some of any of the embodiments described herein, the composition is applied to a plant's or herb's leaf or leaves.

In some of any of the embodiments described herein contacting the plant substrate with a composition as described herein comprises spraying the composition onto the plant's or herb's foliage (e.g., herb's leaf or leaves).

Spraying the composition onto a plant substrate or herb can be effected, for example, by means of a hand-held container (e.g., bottle-shaped) equipped with a spray nozzle, and filled with the composition. The device can be equipped with a hand-operated trigger or valve, which, when operated, dispenses the composition through the spray nozzle. Alternatively or additionally, the device can include means for connecting the spray nozzle to a pressure source (e.g., a fluid source, such as, but not limited to, a source of pressurized water or air), such that the composition is dispensed from the container through the spray nozzle by means of the pressure applied by the pressure source.

Alternatively, spraying can be effected by passing the composition through the spray nozzle by means of a pump. Devices as described herein, which further comprise such a pump are therefore also contemplated. Wheeled machines having means for dispensing the composition through one or more spray nozzles, as a result of a pressure supplied by a pump, and also usable in the context of these embodiments.

Distribution of the composition can also be effected by means of a propeller, optionally connected to a pump.

Also contemplated are systems deployed for distributing the composition on relatively large areas (e.g., at least 100 square meters). Such a system can comprise a controller, a distribution system and a communication channel or network establishing communication between the controller and the distribution system. The controller optionally and preferably includes an electronic circuit configured for operating the distribution system. The system can also comprise a data processor which can be configured to vary the time intervals employed by the controller based on a predetermined criterion or set of criteria.

The distribution system can be, for example, a liquid distribution system such as, but not limited to, a sprinkler system, a center-pivot irrigation system, a drip irrigation system, a mist sprayer system, and the like.

In some of any of the embodiments described herein, contacting the plant substrate with a composition as described herein comprises contacting a plant's root with the composition. Such contacting can be effected by hydroponic irrigation, by adding the composition to the aqueous solution used for hydroponic irrigation. Alternatively, the composition is applies to the soil surrounding the plant's root, by introducing the composition to an irrigation system or by integrating the composition with an irrigation system.

According to some embodiments, an agronomic field in need of plant control is treated by application of the composition directly to the surface of the growing plants, such as by a spray. For example, the method is applied to control weeds in a field of crop plants by spraying the field with the composition. The composition can be provided as a tank mix, a sequential treatment of components, or a simultaneous treatment or mixing of one or more of the components of the composition from separate containers. Treatment of the field can occur as often as needed to provide weed control and the components of the composition can be adjusted to target specific weed species or weed families through utilization of specific compositions capable of selectively targeting the specific species or plant family to be controlled.

According to some of any of the embodiments described herein, the composition as described herein is a herbicidal composition which is for inhibiting growth of a herb (e.g., weed) in the vicinity of the plant substrate.

Weeds, or weedy plants, are plants that compete with cultivated plants.

Exemplary weeds that are treatable by a composition as described herein include, but are not limited to, weeds of the Amaranthus species such as A. albus, A. blitoides, A. hybridus, A. palmeri, A. powellii, A. retroflexus, A. spinosus, A. tuberculatus, and A. viridis; weeds of the Ambrosia species such as A. trifida, A. artemisifolia; weeds of the Lolium species such as L. multiflorum, L. rigidium, L perenne; weeds of the Digitaria species such as D. insularis; weeds of the Euphorbia species such as E. heterophylla; weeds of the Kochia species such as K. scoparia; weeds of the Sorghum species such as S. halepense; weeds of the Conyza species such as C. bonariensis, C. canadensis, C. sumatrensis; weeds of the Chloris species such as C. truncate; weeds of the Echinochloa species such as E. colona, E. crus-galli; weeds of the Eleusine species such as E. indica; weeds of the Poa species such as P. annua; weeds of the Plantago species such as P. lanceolata; weeds of the Avena species such as A. fatua; weeds of the Chenopodium species such as C. album; weeds of the Setaria species such as S. viridis, Abutilon theophrasti; weeds of the Ipomoea species; weeds of Sesbania species; weeds of the Cassia species; weeds of the Sida species; weeds of the Brachiaria species; and weeds of the Solanum species.

Additional weedy plant species found in cultivated areas include Alopecurus myosuroides, Avena sterilis, Avena sterilis ludoviciana, Brachiaria plantaginea, Bromus diandrus, Bromus rigidus, Cynosurus echinatus, Digitaria ciliaris, Digitaria ischaemum, Digitaria sanguinalis, Echinochloa oryzicola, Echinochloa phyllopogon, Eriochloa punctata, Hordeum glaucum, Hordeum leporinum, Ischaemum rugosum, Leptochloa chinensis, Lolium persicum, Phalaris minor, Phalaris paradoxa, Rottboellia exalta, Setaria faberi, Setaria viridis var, robusta-alba schreiber, Setaria viridis var, robusta-purpurea, Snowdenia polystachea, Sorghum sudanese, Alisma plantago-aquatica, Amaranthus lividus, Amaranthus quitensis, Ammania auriculata, Ammania coccinea, Anthemis cotula, Apera spica-venti, Bacopa rotundifolia, Bidens pilosa, Bidens subalternans, Brassica tournefortii, Bromus tectorum, Camelina microcarpa, Chrysanthemum coronarium, Cuscuta campestris, Cyperus difformis, Damasonium minus, Descurainia sophia, Diplotaxis tenuifolia, Echium plantagineum, Elatine triandra var, pedicellata, Euphorbia heterophylla, Fallopia convolvulus, Fimbristylis miliacea, Galeopsis tetrahit, Galium spurium, Helianthus annuus, Iva xanthifolia, Ixophorus unisetus, Ipomoea indica, Ipomoea purpurea, Ipomoea sepiaria, Ipomoea aquatic, Ipomoea triloba, Lactuca serriola, Limnocharis flava, Limnophila erecta, Limnophila sessiliflora, Lindernia dubia, Lindernia dubia var major, Lindernia micrantha, Lindernia procumbens, Mesembryanthemum crystallinum, Monochoria korsakowii, Monochoria vaginalis, Neslia paniculata, Papaver rhoeas, Parthenium hysterophorus, Pentzia suffruticosa, Phalaris minor, Raphanus raphanistrum, Raphanus sativus, Rapistrum rugosum, Rotala indica var, uliginosa, Sagittaria guyanensis, Sagittaria montevidensis, Sagittaria pygmaea, Salsola iberica, Scirpus juncoides var ohwianus, Scirpus mucronatus, Setaria lutescens, Sida spinosa, Sinapis arvensis, Sisymbrium orientale, Sisymbrium thellungii, Solanum ptycanthum, Sonchus aspen, Sonchus oleraceus, Sorghum bicolor, Stellaria media, Thlaspi arvense, Xanthium strumarium, Arctotheca calendula, Conyza sumatrensis, Crassocephalum crepidiodes, Cuphea carthagenenis, Epilobium adenocaulon, Erigeron philadelphicus, Landoltia punctata, Lepidium virginicum, Monochoria korsakowii, Solanum americanum, Solanum nigrum, Vulpia bromoides, Youngia japonica, Hydrilla verticillata, Carduus nutans, Carduus pycnocephalus, Centaurea solstitialis, Cirsium arvense, Commelina diffusa, Convolvulus arvensis, Daucus carota, Digitaria ischaemum, Echinochloa crus-pavonis, Fimbristylis miliacea, Galeopsis tetrahit, Galium spurium, Limnophila erecta, Matricaria perforate, Papaver rhoeas, Ranunculus acris, Soliva sessilis, Sphenoclea zeylanica, Stellaria media, Nassella trichotoma, Stipa neesiana, Agrostis stolonifera, Polygonum aviculare, Alopecurus japonicus, Beckmannia syzigachne, Bromus tectorum, Chloris inflate, Echinochloa erecta, Portulaca oleracea, and Senecio vulgaris.

According to some embodiments of the invention, the weeds include monocotyledonous (monocot) weeds and dicotyledonous (dicot) weeds.

Non-limiting examples of Dicotyledon weed species include Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Emex, Datura, Viola, Galeopsis, Papaver, Trifolium, Abutilon, and Centaurea.

Non-limiting examples of Monocotyledon weed species include Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbris tylis, Sagittaria, Eleocharis, Scirpus, Paspalum, Ischaenum, Sphenoclea, Dactyloctenium, Agrostis, Alopecurus and Apera. According to some of any of the embodiments described herein, the weed is an Amaranthus species, for example, Amaranthus Palmeri (A. Palmeri).

According to some of any of the embodiments described herein, the weed is Echinochloa colonum.

According to some of any of the embodiments described herein, the weed is Lolium multiflorum.

According to some of any of the embodiments described herein, the weed is Solanum nigrum.

According to some of any of the embodiments described herein, the weed is a Setaria species.

According to some of any of the embodiments described herein, the weed is S. Viridis

Crop plants in which weed control is needed include, but are not limited to, i) corn, soybean, cotton, canola, sugar beet, alfalfa, sugarcane, rice, and wheat; ii) vegetable plants including, but not limited to, tomato, sweet pepper, hot pepper, melon, watermelon, cucumber, eggplant, cauliflower, broccoli, lettuce, spinach, onion, peas, carrots, sweet corn, Chinese cabbage, leek, fennel, pumpkin, squash or gourd, radish, Brussels sprouts, tomatillo, garden beans, dry beans, or okra; iii) culinary plants including, but not limited to, basil, parsley, coffee, or tea; iv) fruit plants including, but not limited to, apple, pear, cherry, peach, plum, apricot, banana, plantain, table grape, wine grape, citrus, avocado, mango, or berry; v) a tree grown for ornamental or commercial use, including, but not limited to, a fruit or nut tree; or vi) an ornamental plant (e.g., an ornamental flowering plant or shrub or turf grass). The methods and compositions provided herein can also be applied to plants produced by a cutting, cloning, or grafting process (i.e., a plant not grown from a seed) including fruit trees and plants that include, but are not limited to, citrus, apples, avocados, tomatoes, eggplant, cucumber, melons, watermelons, and grapes, as well as various ornamental plants.

According to some of any of the embodiments described herein, the composition of the present embodiments is for controlling a growth of a pest as described herein in or in the vicinity of a plant substrate as described herein. According to these embodiments, a composition as described herein is a pesticidal composition.

According to some of these embodiments, the pest is a fungus and the composition is a fungicidal composition, usable for inhibiting growth of a fungus in the plant or the vicinity of the plant substrate.

In exemplary embodiments, the fungus is Botrytis cinerea.

In some embodiments, the herbicidal and/or pesticidal composition as described herein is applied to a plant or to an area under cultivation for accomplishing a total vegetative control. In some embodiments, the herbicidal composition is applied to a plant substrate or to the area under cultivation for accomplishing a complete eradication of a weed as described herein.

As used herein, the term “area under cultivation” is intended to include fields, hard landscapes such as driveways, paths, patios, roads, pavements, railways and the like, as well as soil, or established vegetation. Herein, the phrase “plant substrate” encompasses a cultivated plant.

In some embodiments, the herbicidal and/or pesticidal composition is applied, depending on the concentration, for controlling weeds in perennial cultures such as: decorative tree plantings, fruit orchards, vineyards, citrus groves, nut orchards, banana plantations, coffee plantations, tea plantations, rubber plantations, oil palm plantations, cocoa plantations, soft fruit plantings and hop fields, and for the selective combating of weeds in annual cultures.

In some of any of the embodiments described herein, the herbicidal and/or pesticidal composition is applied as a pre-emergent application or as a post-emergent application.

In some embodiments, contacting the plant substrate or the herb or weed with the herbicidal composition is in an amount that ranges between 0.5 grams per hectare (g/ha) and 3000 g/ha, or between 5 g/ha and 2500 g/ha, or between 5 g/ha and 2000 g/ha, or between 50 g/ha and 2500 g/ha, or between 50 grams per hectare (g/ha) and 2000 g/ha, or between 50 g/ha and 1500 g/ha, or between 100 g/ha and 3000 g/ha, or between 100 g/ha and 2500 g/ha, or between 100 grams per hectare (g/ha) and 2000 g/ha, or between 100 g/ha and 1000 g/ha, or between 100 g/ha and 500 g/ha, including any intermediate values and subranges therebetween.

Any of the compositions and uses as described herein can utilize one or more additional herbicides in combination with the anthraquinone compounds as described herein. Such herbicides can be incorporated in the composition or co-applied to the plant substrate as described herein with the composition.

According to some embodiments, a combination of the anthraquinone compounds as described herein with an additional herbicide can provide for a synergistic effect, and/or can be used to treat herbs that are resistant to the additional herbicide, and/or can broaden the spectrum of herbs that are treatable by the additional herbicide.

Exemplary herbicides include, but are not limited to, amide herbicides, aromatic acid herbicides, arsenical herbicides, benzothiazole herbicides, benzoylcyclohexanedione herbicides, benzofuranyl alkylsulfonate herbicides, carbamate herbicides, cyclohexene oxime herbicides, cyclopropylisoxazole herbicides, dicarboximide herbicides, dinitroaniline herbicides, dinitrophenol herbicides, diphenyl ether herbicides, dithiocarbamate herbicides, halogenated aliphatic herbicides, imidazolinone herbicides, inorganic herbicides, nitrile herbicides, organophosphorus herbicides, oxadiazolone herbicides, oxazole herbicides, phenoxy herbicides, phenylenediamine herbicides, pyrazole herbicides, pyridazine herbicides, pyridazinone herbicides, pyridine herbicides, pyrimidinediamine herbicides, pyrimidinyloxybenzylamine herbicides, quaternary ammonium herbicides, thiocarbamate herbicides, thiocarbonate herbicides, thiourea herbicides, triazine herbicides, triazinone herbicides, triazole herbicides, triazolone herbicides, triazolopyrimidine herbicides, uracil herbicides, and urea herbicides.

Representative herbicides of these families include but are not limited to acetochlor, acifluorfen, acifluorfen-sodium, aclonifen, acrolein, alachlor, alloxydim, allyl alcohol, ametryn, amicarbazone, amidosulfuron, aminopyralid, amitrole, ammonium sulfamate, anilofos, asulam, atraton, atrazine, azimsulfuron, BCPC, beflubutamid, benazolin, benfluralin, benfuresate, bensulfuron, bensulfuron-methyl, bensulide, bentazone, benzfendizone, benzobicyclon, benzofenap, bifenox, bilanafos, bispyribac, bispyribac-sodium, borax, bromacil, bromobutide, bromoxynil, butachlor, butafenacil, butamifos, butralin, butroxydim, butylate, cacodylic acid, calcium chlorate, cafenstrole, carbetamide, carfentrazone, carfentrazone-ethyl, CDEA, CEPC, chlorflurenol, chlorflurenol-methyl, chloridazon, chlorimuron, chlorimuron-ethyl, chloroacetic acid, chlorotoluron, chlorpropham, chlorsulfuron, chlorthal, chlorthal-dimethyl, cinidon-ethyl, cinmethylin, cinosulfuron, cisanilide, clethodim, clodinafop, clodinafop-propargyl, clomazone, clomeprop, clopyralid, cloransulam, cloransulam-methyl, CMA, 4-CPB, CPMF, 4-CPP, CPPC, cresol, cumyluron, cyanamide, cyanazine, cycloate, cyclosulfamuron, cycloxydim, cyhalofop, cyhalofop-butyl, 2,4-D, 3,4-DA, daimuron, dalapon, dazomet, 2,4-DB, 3,4-DB, 2,4-DEB, desmedipham, dicamba, dichlobenil, ortho-dichlorobenzene, para-dichlorobenzene, dichlorprop, dichlorprop-P, diclofop, diclofop-methyl, diclosulam, difenzoquat, difenzoquat metilsulfate, diflufenican, diflufenzopyr, r, dimefuron, dimepiperate, dimethachlor, dimethametryn, dimethenamid, dimethenamid-P, dimethipin, dimethylarsinic acid, dinitramine, dinoterb, diphenamid, diquat, diquat dibromide, dithiopyr, diuron, DNOC, 3,4-DP, DSMA, EBEP, endothal, EPTC, esprocarb, ethalfluralin, ethametsulfuron, ethametsulfuron-methyl, ethofumesate, ethoxyfen, ethoxysulfuron, etobenzanid, fenoxaprop-P, fenoxaprop-P-ethyl, fentrazamide, ferrous sulfate, flamprop-M, flazasulfuron, florasulam, fluazifop, fluazifop-butyl, fluazifop-P, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, fluoroglycofen, fluoroglycofen-ethyl, flupropanate, flupyrsulfuron, flupyrsulfuron-methyl-sodium, flurenol, fluridone, fluorochloridone, fluoroxypyr, flurtamone, fluthiacet, fluthiacet-methyl, fomesafen, foramsulfuron, fosamine, glufosinate, glufosinate-ammonium, glyphosate, halosulfuron, halosulfuron-methyl, haloxyfop, haloxyfop-P, HC-252, hexazinone, imazamethabenz, imazamethabenz-methyl, imazamox, imazapic, imazapyr, imazaquin, imazethapyr, imazosulfuron, indanofan, iodomethane, iodosulfuron, iodosulfuron-methyl-sodium, ioxynil, isoproturon, isouron, isoxaben, isoxachlortole, isoxaflutole, karbutilate, lactofen, lenacil, linuron, MAA, MAMA, MCPA, MCPA-thioethyl, MCPB, mecoprop, mecoprop-P, mefenacet, mefluidide, mesosulfuron, mesosulfuron-methyl, mesotrione, metam, metamifop, metamitron, metazachlor, methabenzthiazuron, methylarsonic acid, methyldymron, methyl isothiocyanate, metobenzuron, metolachlor, S-metolachlor, metosulam, metoxuron, metribuzin, metsulfuron, metsulfuron-methyl, MK-66, molinate, monolinuron, MSMA, naproanilide, napropamide, naptalam, neburon, nicosulfuron, nonanoic acid, norflurazon, oleic acid (fatty acids), orbencarb, orthosulfamuron, oryzalin, oxadiargyl, oxadiazon, oxasulfuron, oxaziclomefone, oxyfluorfen, paraquat, paraquat dichloride, pebulate, pendimethalin, penoxsulam, pentachlorophenol, pentanochlor, pentoxazone, pethoxamid, petrolium oils, phenmedipham, phenmedipham-ethyl, picloram, picolinafen, pinoxaden, piperophos, potassium arsenite, potassium azide, pretilachlor, primisulfuron, primisulfuron-methyl, prodiamine, profluazol, profoxydim, prometon, prometryn, propachlor, propanil, propaquizafop, propazine, propham, propisochlor, propoxycarbazone, propoxycarbazone-sodium, propyzamide, prosulfocarb, prosulfuron, pyraclonil, pyraflufen, pyraflufen-ethyl, pyrazolynate, pyrazosulfuron, pyrazosulfuron-ethyl, pyrazoxyfen, pyribenzoxim, pyributicarb, pyridafol, pyridate, pyriftalid, pyriminobac, pyriminobac-methyl, pyrimisulfan, pyrithiobac, pyrithiobac-sodium, quinclorac, quinmerac, quinoclamine, quizalofop, quizalofop-P, rimsulfuron, sethoxydim, siduron, simazine, simetryn, SMA, sodium arsenite, sodium azide, sodium chlorate, sulcotrione, sulfentrazone, sulfometuron, sulfometuron-methyl, sulfosate, sulfosulfuron, sulfuric acid, tar oils, 2,3,6-TBA, TCA, TCA-sodium, tebuthiuron, tepraloxydim, terbacil, terbumetone, terbuthylazine, terbutryn, thenylchlor, thiazopyr, thifensulfuron, thifensulfuron-methyl, thiobencarb, tiocarbazil, topramezone, tralkoxydim, tri-allate, triasulfuron, triaziflam, tribenuron, tribenuron-methyl, tricamba, triclopyr, trietazine, trifloxysulfuron, trifloxysulfuron-sodium, trifluralin, triflusulfuron, triflusulfuron-methyl, trihydroxytriazine, tritosulfuron, [3-[2-chloro-4-fluoro-5-(methyl-6-trifluoromethyl-2,4-dioxo-2,3,4-tetrahy-dropyrimidin-3-yl) phenoxy]-2-pyridyloxy]acetic acid ethyl ester (CAS RN 353292-3-6), 4-[(4,5-dihydro-3-methoxy-4-methyl-5-oxo)-H—, 2,4-triazolylcarbonyl-sulfam-oyl]-5-methylthiophene-3-carboxylic acid (BAY636), BAY747 (CAS RN 33504-84-2), topramezone (CAS RN 2063-68-8), 4-hydroxy-3-[[2-[(2-methoxyethoxy)methyl]-6-(trifluoro-methyl)-3-pyridiny-1]carbonyl]-bicyclo[3.2.]oct-3-en-2-one (CAS RN 35200-68-5), and 4-hydroxy-3-[[2-(3-methoxypropyl)-6-(difluoromethyl)-3-pyridinyl]carbonyl-]-bicyclo[3.2.]oct-3-en-2-one.

According to some embodiments of the present invention, a pesticidal composition as described herein further includes, or be used in combination with various agricultural chemicals and/or insecticides, miticides and fungicides, pesticidal and biopesticidal agents. Examples include but are not limited to azinphos-methyl, acephate, isoxathion, isofenphos, ethion, etrimfos, oxydemeton-methyl, oxydeprofos, quinalphos, chlorpyrifos, chlorpyrifos-methyl, chlorfenvinphos, cyanophos, dioxabenzofos, dichlorvos, disulfoton, dimethylvinphos, dimethoate, sulprofos, diazinon, thiometon, tetrachlorvinphos, temephos, tebupirimfos, terbufos, naled, vamidothion, pyraclofos, pyridafenthion, pirimiphos-methyl, fenitrothion, fenthion, phenthoate, flupyrazophos, prothiofos, propaphos, profenofos, phoxime, phosalone, phosmet, formothion, phorate, malathion, mecarbam, mesulfenfos, methamidophos, methidathion, parathion, methyl parathion, monocrotophos, trichlorphon, EPN, isazophos, isamidofos, cadusafos, diamidaphos, dichlofenthion, thionazin, fenamiphos, fosthiazate, fosthietan, phosphocarb, DSP, ethoprophos, alanycarb, aldicarb, isoprocarb, ethiofencarb, carbaryl, carbosulfan, xylylcarb, thiodicarb, pirimicarb, fenobucarb, furathiocarb, propoxur, bendiocarb, benfuracarb, methomyl, metolcarb, XMC, carbofuran, aldoxycarb, oxamyl, acrinathrin, allethrin, esfenvalerate, empenthrin, cycloprothrin, cyhalothrin, gamma-cyhalothrin, lambda-cyhalothrin, cyfluthrin, beta-cyfluthrin, cypermethrin, alpha-cypermethrin, zeta-cypermethrin, silafluofen, tetramethrin, tefluthrin, deltamethrin, tralomethrin, bifenthrin, phenothrin, fenvalerate, fenpropathrin, furamethrin, prallethrin, flucythrinate, fluvalinate, flubrocythrinate, permethrin, resmethrin, etofenprox, cartap, thiocyclam, bensultap, acctamiprid, imidacloprid, clothianidin, dinotefuran, thiacloprid, thiamethoxam, nitenpyram, chlorfluazuron, diflubenzuron, teflubenzuron, triflumuron, novaluron, noviflumuron, bistrifluoron, fluazuron, flucycloxuron, flufenoxuron, hexaflumuron, lufenuron, chromafenozide, tebufenozide, halofenozide, methoxyfenozide, diofenolan, cyromazine, pyriproxyfen, buprofezin, methoprene, hydroprene, kinoprene, triazamate, endosulfan, chlorfenson, chlorobenzilate, dicofol, bromopropylate, acetoprole, fipronil, ethiprole, pyrethrin, rotenone, nicotine sulphate, BT (Bacillus Thuringiensis) agent, spinosad, abamectin, acequinocyl, amidoflumet, amitraz, etoxazole, chinomethionat, clofentezine, fenbutatin oxide, dienochlor, cyhexatin, spirodiclofen, spiromesifen, tetradifon, tebufenpyrad, binapacryl, bifenazate, pyridaben, pyrimidifen, fenazaquin, fenothiocarb, fenpyroximate, fluacrypyrim, fluazinam, flufenzin, hexythiazox, propargite, benzomate, polynactin complex, milbemectin, lufenuron, mecarbam, methiocarb, mevinphos, halfenprox, azadirachtin, diafenthiuron, indoxacarb, emamectin benzoate, potassium oleate, sodium oleate, chlorfenapyr, tolfenpyrad, pymetrozine, fenoxycarb, hydramethylnon, hydroxy propyl starch, pyridalyl, flufenerim, flubendiamide, flonicamid, metaflumizole, lepimectin, TPIC, albendazole, oxibendazole, oxfendazole, trichlamide, fensulfothion, fenbendazole, levamisole hydrochloride, morantel tartrate, dazomet, metam-sodium, triadimefon, hexaconazole, propiconazole, ipconazole, prochloraz, triflumizole, tebuconazole, epoxiconazole, difenoconazole, flusilazole, triadimenol, cyproconazole, metconazole, fluquinconazole, bitertanol, tetraconazole, triticonazole, flutriafol, penconazole, diniconazole, fenbuconazole, bromuconazole, imibenconazole, simeconazole, myclobutanil, hymexazole, imazalil, furametpyr, thifluzamide, etridiazole, oxpoconazole, oxpoconazole fumarate, pefurazoate, prothioconazole, pyrifenox, fenarimol, nuarimol, bupirimate, mepanipyrim, cyprodinil, pyrimethanil, metalaxyl, mefenoxam, oxadixyl, benalaxyl, thiophanate, thiophanate-methyl, benomyl, carbendazim, fuberidazole, thiabendazole, manzeb, propineb, zineb, metiram, maneb, ziram, thiuram, chlorothalonil, ethaboxam, oxycarboxin, carboxin, flutolanil, silthiofam, mepronil, dimethomorph, fenpropidin, fenpropimorph, spiroxamine, tridemorph, dodemorph, flumorph, azoxystrobin, 1 metominostrobin, orysastrobin, fluoxastrobin, trifloxystrobin, dimoxystrobin, pyraclostrobin, picoxystrobin, iprodione, procymidone, vinclozolin, chlozolinate, flusulfamide, dazomet, methyl isothiocyanate, chloropicrin, methasulfocarb, hydroxyisoxazole, potassium hydroxyisoxazole, echlomezol, D-D, carbam, basic copper chloride, basic copper sulfate, copper nonylphenolsulfonate, oxine copper, DBEDC, anhydrous copper sulfate, copper sulfate pentahydrate, cupric hydroxide, inorganic sulfur, wettable sulfur, lime sulfur, zinc sulfate, fentin, sodium hydrogen carbonate, potassium hydrogen carbonate, sodium hypochlorite, silver, edifenphos, tolclofos-methyl, fosetyl, iprobenfos, dinocap, pyrazophos, carpropamid, fthalide, tricyclazole, pyroquilon, diclocymet, fenoxanil, kasugamycin, validamycin, polyoxins, blasticiden S, oxytetracycline, mildiomycin, streptomycin, rape seed oil, machine oil, benthiavalicarbisopropyl, iprovalicarb, propamocarb, diethofencarb, fluoroimide, fludioxanil, fenpiclonil, quinoxyfen, oxolinic acid, chlorothalonil, captan, folpet, probenazole, acibenzolar-S-methyl, tiadinil, cyflufenamid, fenhexamid, diflumetorim, metrafenone, picobenzamide, proquinazid, famoxadone, cyazofamid, fenamidone, zoxamide, boscalid, cymoxanil, dithianon, fluazinam, dichlofluanide, triforine, isoprothiolane, ferimzone, diclomezine, tecloftalam, pencycuron, chinomethionat, iminoctadine acetate, iminoctadine albesilate, ambam, polycarbamate, thiadiazine, chloroneb, nickel dimethyldithiocarbamate, guazatine, dodecylguanidine-acetate, quintozene, tolylfluanid, anilazine, nitrothalisopropyl, fenitropan, dimethirimol, benthiazole, harpin protein, flumetover, mandipropamide and penthiopyrad.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

The term “alkyl” describes a saturated aliphatic hydrocarbon including straight chain and branched chain groups. Preferably, the alkyl group has 1 to 20 carbon atoms. Whenever a numerical range; e.g., “1-20”, is stated herein, it implies that the group, in this case the alkyl group, may contain 1 carbon atom, 2 carbon atoms, 3 carbon atoms, etc., up to and including 20 carbon atoms. More preferably, the alkyl is a medium size alkyl having 2 to 10 carbon atoms. Most preferably, unless otherwise indicated, the alkyl is a lower alkyl having 2 to 6 carbon atoms. The alkyl group may be substituted or unsubstituted, as defined herein.

The term “cycloalkyl” or “alicyclic” describes an all-carbon monocyclic or fused ring (i.e., rings which share an adjacent pair of carbon atoms) group where one or more of the rings does not have a completely conjugated pi-electron system. The cycloalkyl group may be substituted or unsubstituted.

The term “heteroalicyclic” describes a monocyclic or fused ring group having in the ring(s) one or more atoms such as nitrogen, oxygen and sulfur. The rings may also have one or more double bonds. However, the rings do not have a completely conjugated pi-electron system. The heteroalicyclic may be substituted or unsubstituted. Representative examples are piperidine, piperazine, tetrahydrofurane, tetrahydropyrane, morpholino and the like.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted.

Whenever an alkyl, cycloalkyl, heteroalicyclic, aryl, heteroaryl or a hydrocarbon is substituted by one or more substituents, each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine.

A “hydroxy” group refers to an —OH group.

An “azide” group refers to a —N═N⁺═N⁻ group.

An “alkoxy” group refers to both an —O-alkyl and an —O-cycloalkyl group, as defined herein.

An “aryloxy” group refers to both an —O-aryl and an —O-heteroaryl group, as defined herein.

A “thiohydroxy” or “thiol” group refers to a —SH group.

A “thioalkoxy” group refers to both an —S-alkyl group, and an —S-cycloalkyl group, as defined herein.

A “thioaryloxy” group refers to both an —S-aryl and an —S-heteroaryl group, as defined herein.

A “carbonyl” group refers to a —C(═O)—R′ group, where R′ is defined as hereinabove. An acetyl is a carbonyl, as defined herein, wherein R′ is a substituted or unsubstituted methyl.

A “thiocarbonyl” group refers to a —C(═S)—R′ group, where R′ is as defined herein.

A “C-carboxy” group refers to a —C(═O)—O—R′ groups, where R′ is as defined herein.

An “O-carboxy” group refers to an R′C(═O)—O— group, where R′ is as defined herein.

An “oxo” group refers to a ═O group.

A “carboxylate” or “carboxyl” encompasses both C-carboxy and O-carboxy groups, as defined herein.

A “carboxylic acid” group refers to a C-carboxy group in which R′ is hydrogen.

A “thiocarboxy” or “thiocarboxylate” group refers to both —C(═S)—O—R′ and —O—C(═S) R′ groups.

An “ester” refers to a C-carboxy group wherein R′ is not hydrogen.

An ester bond refers to a —O—C(═O)— bond.

A “halo” group refers to fluorine, chlorine, bromine or iodine.

A “sulfinyl” group refers to an —S(═O)—R′ group, where R′ is as defined herein.

A “sulfonyl” group refers to an —S(═O)₂—R′ group, where R′ is as defined herein.

A “sulfonate” group refers to an —S(═O)₂—O—R′ group, where R′ is as defined herein.

A “sulfate” group refers to an —O—S(═O)₂—O—R′ group, where R′ is as defined as herein.

A “sulfonamide” or “sulfonamido” group encompasses both S-sulfonamido and N-sulfonamido groups, as defined herein.

An “S-sulfonamido” group refers to a —S(═O)₂—NR′R″ group, with each of R′ and R″ as defined herein.

An “N-sulfonamido” group refers to an R'S(═O)₂—NR″ group, where each of R′ and R″ is as defined herein.

An “O-carbamyl” group refers to an —OC(═O)—NR′R″ group, where each of R′ and R″ is as defined herein.

An “N-carbamyl” group refers to an R′OC(═O)—NR″— group, where each of R′ and R″ is as defined herein.

A “carbamyl” or “carbamate” group encompasses O-carbamyl and N-carbamyl groups.

A carbamate bond describes a —O—C(═O)—NR′— bond, where R′ is as described herein.

An “O-thiocarbamyl” group refers to an —OC(═S)—NR′R″ group, where each of R′ and R″ is as defined herein.

An “N-thiocarbamyl” group refers to an R′OC(═S) NR″— group, where each of R′ and R″ is as defined herein.

A “thiocarbamyl” or “thiocarbamate” group encompasses O-thiocarbamyl and N-thiocarbamyl groups.

A thiocarbamate bond describes a —O—C(═S)—NR′— bond, where R′ is as described herein.

A “C-amido” group refers to a —C(═O)—NR′R″ group, where each of R′ and R″ is as defined herein.

An “N-amido” group refers to an R′C(═O)—NR″— group, where each of R′ and R″ is as defined herein.

An “amide” group encompasses both C-amido and N-amido groups.

An amide bond describes a —NR′—C(═O)— bond, where R′ is as defined herein.

A “urea” group refers to an —N(R′)—C(═O)—NR″R′″ group, where each of R′ and R″ is as defined herein, and R′″ is defined as R′ and R″ are defined herein.

A “nitro” group refers to an —NO₂ group.

A “cyano” group refers to a —C═N group.

The term “phosphonyl” or “phosphonate” describes a —P(═O) (OR′) (OR″) group, with R′ and R″ as defined hereinabove.

The term “phosphate” describes an —O—P(═O) (OR′) (OR″) group, with each of R′ and R″ as defined hereinabove.

A “phosphoric acid” is a phosphate group is which each of R is hydrogen.

The term “phosphinyl” describes a —PR′R″ group, with each of R′ and R″ as defined hereinabove.

The term “thiourea” describes a —N(R′)—C(═S)—NR″— group, with each of R′ and R″ as defined hereinabove.

As used herein, the term “amine” describes both a —NR′R″ group, wherein R′ and R″ are each independently hydrogen, alkyl, cycloalkyl, aryl, as these terms are defined hereinbelow.

The amine group can therefore be a primary amine, where both R′ and R″ are hydrogen, a secondary amine, where R′ is hydrogen and R″ is alkyl, cycloalkyl or aryl, or a tertiary amine, where each of R′ and R″ is independently alkyl, cycloalkyl or aryl.

Alternatively, R′ and R″ can each independently be hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, carbonyl, C-carboxylate, O-carboxylate, N-thiocarbamate, O-thiocarbamate, urea, thiourea, N-carbamate, O-carbamate, C-amide, N-amide, guanyl, guanidine and hydrazine, as defined herein.

Herein throughout, R, R′ and R″ are each independently hydrogen, alkyl, cycloalkyl, or aryl, as these terms are defined herein, and can alternatively be each independently hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, carbonyl, C-carboxylate, O-carboxylate, N-thiocarbamate, O-thiocarbamate, urea, thiourea, N-carbamate, O-carbamate, C-amide, N-amide, guanyl, guanidine and hydrazine, as these terms are defined herein.

As used herein, the term “alkylene glycol” describes a —O—[(CR′R″)_{z}—O]_{y}—R′″ end group or a —O—[(CR′R″)_{z}—O]_{y}-linking group, with R′, R″ and R′″ being as defined herein, and with z being an integer of from 1 to 10, preferably, from 2 to 6, more preferably 2 or 3, and y being an integer of 1 or more. Preferably R′ and R″ are both hydrogen. When z is 2 and y is 1, this group is ethylene glycol. When z is 3 and y is 1, this group is propylene glycol. When y is 2-4, the alkylene glycol is referred to herein as oligo (alkylene glycol). Any of the compounds (e.g., active agents, compound of Formula I) described herein can be in a form of a pharmaceutically acceptable salt thereof.

The term “saccharide” as used herein encompasses monosaccharides, disaccharides and oligosaccharides. The term “monosaccharide”, as used herein and is well known in the art, refers to a simple form of a sugar that consists of a single saccharide molecule which cannot be further decomposed by hydrolysis. Most common examples of monosaccharides include glucose (dextrose), fructose, galactose, and ribose. Monosaccharides can be classified according to the number of carbon atoms of the carbohydrate, i.e., triose, having 3 carbon atoms such as glyceraldehyde and dihydroxyacetone; tetrose, having 4 carbon atoms such as erythrose, threose and erythrulose; pentose, having 5 carbon atoms such as arabinose, lyxose, ribose, xylose, ribulose and xylulose; hexose, having 6 carbon atoms such as allose, altrose, galactose, glucose, gulose, idose, mannose, talose, fructose, psicose, sorbose and tagatose; heptose, having 7 carbon atoms such as mannoheptulose, sedoheptulose; octose, having 8 carbon atoms such as 2-keto-3-deoxy-manno-octonate; nonose, having 9 carbon atoms such as sialose; and decose, having 10 carbon atoms. Monosaccharides are the building blocks of oligosaccharides like sucrose (common sugar).

In exemplary embodiments, the saccharide is a glycoside.

Any of the compounds described herein can be in a form of an agriculturally acceptable salt thereof.

The phrase “agriculturally acceptable salt” refers to a charged species of the parent compound and its counter ion, which is typically used to modify the solubility characteristics of the parent compound and/or to reduce any significant adverse effect to an agricultural substrate by the parent compound, while not abrogating the biological activity and properties of the administered compound.

In the context of some of the present embodiments, an agriculturally acceptable salt of the compounds described herein may optionally be a base addition salt comprising at least one acidic (e.g., carboxylic acid) group of the compound which is in a negatively charged form (e.g., wherein the acidic group is deprotonated), in combination with at least one counter-ion, derived from the selected base, that forms an agriculturally acceptable salt.

The base addition salts of the compounds described herein may therefore be complexes formed between one or more acidic groups of the drug and one or more equivalents of a base.

The base addition salts may include a variety of organic and inorganic counter-ions and bases, such as, but not limited to, sodium (e.g., by addition of NaOH), potassium (e.g., by addition of KOH), calcium (e.g., by addition of Ca(OH)₂, magnesium (e.g., by addition of Mg(OH)₂), aluminum (e.g., by addition of Al(OH)₃ and ammonium (e.g., by addition of ammonia). Each of these acid addition salts can be either a mono-addition salt or a poly-addition salt, as these terms are defined herein.

In the context of some of the present embodiments, a pharmaceutically acceptable salt of the compounds described herein may optionally be an acid addition salt comprising at least one base group (e.g., amine group) of the compound which is in a positively charged form (e.g., wherein an amine group is protonated), in combination with at least one counter-ion, derived from the selected acid, that forms an agriculturally acceptable salt.

The acid addition salts of the compounds described herein may therefore be complexes formed between one or more basic groups of the drug and one or more equivalents of an acid.

The acid addition salts may include a variety of organic and inorganic acids, such as, but not limited to, hydrochloric acid which affords a hydrochloric acid addition salt, hydrobromic acid which affords a hydrobromic acid addition salt, acetic acid which affords an acetic acid addition salt, ascorbic acid which affords an ascorbic acid addition salt, benzenesulfonic acid which affords a besylate addition salt, camphorsulfonic acid which affords a camphorsulfonic acid addition salt, citric acid which affords a citric acid addition salt, maleic acid which affords a maleic acid addition salt, malic acid which affords a malic acid addition salt, methanesulfonic acid which affords a methanesulfonic acid (mesylate) addition salt, naphthalenesulfonic acid which affords a naphthalenesulfonic acid addition salt, oxalic acid which affords an oxalic acid addition salt, phosphoric acid which affords a phosphoric acid addition salt, toluenesulfonic acid which affords a p-toluenesulfonic acid addition salt, succinic acid which affords a succinic acid addition salt, sulfuric acid which affords a sulfuric acid addition salt, tartaric acid which affords a tartaric acid addition salt and trifluoroacetic acid which affords a trifluoroacetic acid addition salt. Each of these acid addition salts can be either a mono-addition salt or a poly-addition salt, as these terms are defined herein.

Depending on the stoichiometric proportions between the charged group(s) in the compound and the counter-ion in the salt, the acid or base additions salts can be either mono-addition salts or poly-addition salts.

The phrase “mono-addition salt”, as used herein, refers to a salt in which the stoichiometric ratio between the counter-ion and charged form of the compound is 1:1, such that the addition salt includes one molar equivalent of the counter-ion per one molar equivalent of the compound.

The phrase “poly-addition salt”, as used herein, refers to a salt in which the stoichiometric ratio between the counter-ion and the charged form of the compound is greater than 1:1 and is, for example, 2:1, 3:1, 4:1 and so on, such that the addition salt includes two or more molar equivalents of the counter-ion per one molar equivalent of the compound.

The present invention further encompasses prodrugs, solvates and hydrates of the substances described herein.

As used herein, the term “prodrug” refers to an agent, which is converted into the active compound (the active parent drug) upon application to the target substrate. Prodrugs are typically useful for facilitating the storage and/or application of the parent compound. They may, for instance, be more bioavailable whereas the parent compound is not. The prodrug may also have improved solubility and/or stability as compared with the parent compound in agricultural compositions (e.g., pesticidal or herbicidal formulations). Prodrugs are also often used to achieve a sustained release of the active compound. A prodrug may comprise, for example, the active compound modified with ester groups, for example, wherein any one or more of the hydroxyl groups of a compound is modified by an acyl group, optionally (C₁₋₄) acyl (e.g., acetyl) group to form an ester group, and/or any one or more of the carboxylic acid groups of the compound is modified by an alkoxy or aryloxy group, optionally (C₁₋₄)alkoxy (e.g., methyl, ethyl) group to form an ester group.

The term “solvate” refers to a complex of variable stoichiometry (e.g., di-, tri-, tetra-, penta-, hexa-, and so on), which is formed by a solute (the compound as described herein) and a solvent, whereby the solvent does not interfere with the activity of the solute. Suitable solvents include, for example, ethanol, acetic acid and the like.

The term “hydrate” refers to a solvate, as defined hereinabove, where the solvent is water.

The compounds described herein can be used as polymorphs and the present embodiments further encompass any isomorph of the compounds and any combination thereof.

The present embodiments further encompass any enantiomers and diastereomers of the compounds described herein.

As used herein, the term “enantiomer” refers to a stereoisomer of a compound that is superposable with respect to its counterpart only by a complete inversion/reflection (mirror image) of each other. Enantiomers are said to have “handedness” since they refer to each other like the right and left hand. Enantiomers have identical chemical and physical properties except when present in an environment which by itself has handedness, such as all living systems. In the context of the present embodiments, a compound may exhibit one or more chiral centers, each of which exhibiting an R- or an S-configuration and any combination, and compounds according to some embodiments of the present invention, can have any their chiral centers exhibit an R- or an S-configuration.

The term “diastereomers”, as used herein, refers to stereoisomers that are not enantiomers to one another. Diastereomerism occurs when two or more stereoisomers of a compound have different configurations at one or more, but not all of the equivalent (related) stereocenters and are not mirror images of each other. When two diastereoisomers differ from each other at only one stereocenter they are epimers. Each stereo-center (chiral center) gives rise to two different configurations and thus to two different stereoisomers. In the context of the present invention, embodiments of the present invention encompass compounds with multiple chiral centers that occur in any combination of stereo-configuration, namely any diastereomer.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Design

In the course of computational screening using big-data analysis platforms, and several optimization cycles performed in silico, the present inventors have identified 36 anthraquinone compounds, and have tested these compounds in preliminary growth-chamber assays, in order to identify compounds that exhibit an herbicidal activity.

The herbicidal activity was determined by post-emergence application on 8-day old plants (weeds) of the Amaranthus palmeri species that were grown at 16 hours/8 hours day/night cycles at 30° C./25° C., respectively. Leaf stage was typically 4-6 for A. palmeri.

In each treatment, one 9-pack, containing about 9 Amaranthus palmeri plants, were sprayed using a VL-SET Paasche Airbrush with 0.3-1.5 ml solution containing 0.125-2 mg/ml of a tested compound, which is equivalent to about 125-2000 g/ha.

Herbicidal activity was assessed and scored 3-4 days after application by visual inspection of the plants in comparison to plants treated with the formulation alone (with no active ingredient) as control.

Eight (8) anthraquinone compounds were identified as promising candidates, the structures of which are shown in FIG. 1, and were subjected to further tests for herbicidal and/or pesticidal activity.

### Example 2

### Growth-Chamber Assays

Each of the leading anthraquinone compounds (shown in FIG. 1) was tested in growth-chamber post-emergence assays.

Herbicidal activity was determined by post-emergence application on 8-day old plants (weeds) of the Amaranthus palmeri and Setaria viridis species that were grown at 16 hours/8 hours day/night cycles at 30° C./25° C., respectively. Leaf stage was typically 4-6 for A. palmeri and 3-4 for S. viridis.

In each treatment, 2-3 pots, each containing about 5 plants each (for Setaria viridis), and one 9-pack, containing about 9 plants (for Amaranthus palmeri), were sprayed using a VL-SET Paasche Airbrush with 0.3-1.5 ml solution containing 0.125-2 mg/ml of a tested compound, which is equivalent to about 125-2000 g/ha.

Damage assessment: Herbicidal activity was assessed and scored 3-4 days after application by visual inspection of the plants in comparison to plants treated with the formulation alone (with no active ingredient) as control. Activity score is in the range of 0 to 100, where 0 represents no herbicidal activity like control plants and 100 represents the maximal herbicidal activity (i.e., total death of the plant).

Formulation design: Compounds were tested on A. Palmeri in various formulations, and in varying concentrations for each of the tested formulations, in order to determine optimal conditions for its application and performance. Activity scores were determined as described hereinabove. Solubility scores were determined by visual inspection on a scale of 1-10, with 10 representing complete solubilization and 1 represents nullified solubilization.

### Results:

### Formulation Design:

Various combinations of the following formulation components were tested, at a concentration within the indicated range. Each formulation was tested for its solubility (by visual inspection) and its herbicidal activity on A. Palmeri (scored as described herein), with Low representing activity score in the range of 0-30, Medium representing activity score in the range of 31-70 and High representing activity score in the range of 71-100. All tested formulations were aqueous-based formulations, containing water, optionally in combination with an organic solvent as emulsion.

Components of the various tested formulations and the tested concentration range thereof, for each compound at a concentration range as indicated, are presented in Tables 1A and 1B below.

Formulation preparation generally included solubilizing the tested compound either in water, an ionizing aqueous medium (for carboxylic acid-containing compounds), an organic solvent medium, or by forming an emulsion (for all compounds), in the presence of one or more emulsifiers. Various solubilization media were tested for each compound (optionally in combination with various emulsifiers), as follows:

For Compound 1: water, DMSO in water (0.1-6%); 50 mM Tris buffer at a pH in a range of 7.5-8.5; 0.8-6.4 mM potassium hydroxide (pH=8-9), 1.5-2 mM ammonium hydroxide (pH=8-9), 5-11 mM Mono-Iso-Propyl-Amine (MIPA; pH=7-9), 100% xylene; 100% ethanol; 20% ethanol in water; 100% ethyl acetate; 20% ethyl acetate in water; 100% n-butanol; a mixture of 88% xylene and 12% NMP.

For Compound 4: water, DMSO in water (1-6%); 6% ethyl lactate; 24% acetone; a mixture of 8.6% xylene and 1.4% NMP; mixtures of acetophenone (4.3 or 8.6%) and NMP (0.7 or 1.4%); 100% Dichloromethane; 100% Xylene; 100% ethyl acetate; 100% monochlorobenzene; 100% 2-ethyl-1-hexanol; 100% ethyl lactate; 100% acetophenone; 100% DMSO; 100% NMP.

For Compound 2: water, DMSO in water (2%); a mixture of acetophenone (8.6%) and NMP (1.4%); 50 mM Tris buffer pH 8; combinations of the forgoing; 100% Xylene.

For Compound 6, Compound 3 and Compound 7: DMSO in water (2%); a mixture of acetophenone (8.6%) and NMP (1.4%); 50 mM Tris buffer pH 8; combinations of the forgoing.

For Compound 5: DMSO in water (0.5-2%); a mixture of acetophenone (8.6%) and NMP (1.4%); 50 mM Tris buffer pH 8.

For Compound 1A: 50 mM Tris buffer pH 8.

Adjuvants, for improving penetration into the plant (weed)'s system were also screened for each compound and/or each solubilization medium in order to uncover the most suitable combination.

Based on the determined solubility scores (on a scale of 1-10) and herbicidal activity scores (low representing 1-30; medium representing 31-70 and high representing 71-100), as defined herein, formulations that exhibit a solubility score of 10 and high herbicidal activity, for each of the tested compounds, were identified (detailed data obtained for each of the tested formulations for each compound not shown).

TABLE 1A

| | | Comp. 1 | Comp. 1A | Comp. 1B | Comp. 2 |
|---|---|---|---|---|---|
| | | (0.25-4 | (0.4-1 | (0.5-1.2 | (0.25-3 |
| Component | Function | mg/ml) | mg/ml) | mg/ml) | mg/ml) |
| Break-Thru ® (BT) | adjuvant | 0.05-0.5 | 0.05 | 0.05 | 0.05 |
| Calcium Dodecylbenzene | emulsifier | 0.05-0.5 | | 0.1 | 0.06-0.5 |
| Sulfonate (Ca-LAS; e.g., | | | | | |
| Rhodacal ® 60be by Solavy) | | | | | |
| Ethoxylated castor oil (ECO, | emulsifier | 0.5 | | | 0.06-0.5 |
| e.g., Kolliphor ® RH 40) | | | | | |
| Tween ®20 | adjuvant | 1-4 | 2 | 2 | 1-4 |
| Tween ®80 | adjuvant | 0.5-1 | | | 0.66-1 |
| Ethoxylated Tallow Amine | adjuvant | 0.025-0.05 | | | |
| (e.g., Adsee ™ 907) | | | | | |
| Sodium Lauryl Ether sulfate | adjuvant | 0.7 | | 0.7 | |
| Methylated Rapeseed oil | adjuvant | 1-2 | | 2 | |
| (e.g., AGNIQUE ®) | | | | | |
| Hasten ™ | adjuvant | 2 | | 2 | |
| Genapol X-080 Isotridecyl | adjuvant | 0.25-0.1 | | 0.25 | |
| alcohol polyglycol ether (8EO) | | | | | |
| Dash ® HC | adjuvant | 1-2 | | | |
| Tristyrylphenol Ethoxylate | emulsifier | 0.02 | | 0.04 | |
| (e.g., Soprophor ®Bsu by | | | | | |
| Solvay) | | | | | |
| AG-HRO ® Fkc 1000 by | adjuvant | 0.25 | | | |
| Solvay | | | | | |
| 1-methyl-2-pyrolidone (NMP) | solubilizer | 1.4 | | | 0.18-1.4 |
| acetophenone | solubilizer | 8.6 | | | 1.1-8.6 |
| acetone | solubilizer | | | | |
| Xylene | solubilizer | 2 | | | |
| Dimethylsulfoxide (DMSO) | solubilizer | 0.5-2 | | | 0.66-2 |
| Ethyl lactate | solubilizer | | | | |
| 50 mM Tris Buffer pH = 8 | solubilizer | ✓ | ✓ | ✓ | ✓ |
| 0.8-6.4 mM Potassium | solubilizer | ✓ | | | |
| hydroxide, pH = 8-9 | | | | | |
| 1-5.2 mM Ammonium | solubilizer | ✓ | | | |
| hydroxide, pH = 8-9 | | | | | |
| 5-11 mM Mono-Iso-Propyl- | solubilizer | ✓ | | ✓ | |
| Amine (MIPA), pH = 7-9 | | | | | |

TABLE 1B

| | | | Comp. 4 | Comp. 5 | Comp. 6 | |
|---|---|---|---|---|---|---|
| | | Comp. 3 | (0.25-4 | (0.2-2 | (0.5-2 | Comp. 7 |
| Component | Function | (2 mg/ml) | mg/ml) | mg/ml) | mg/ml) | (2 mg/ml) |
| Break-Thru ® (BT) | adjuvant | 0.05 | 0.05 | 0.05 | 0.05 | 0.05 |
| Calcium Dodecylbenzene | emulsifier | 0.5 | 0.125-0.5 | 0.25-0.5 | 0.5 | 0.5 |
| Sulfonate (Ca-LAS; e.g., | | | | | | |
| Rhodacal ® 60be by | | | | | | |
| Solavy) | | | | | | |
| Ethoxylated castor oil | emulsifier | 0.5 | 0.125-0.5 | 0.25-0.5 | 0.5 | 0.5 |
| (ECO, e.g., Kolliphor ® | | | | | | |
| RH 40) | | | | | | |
| Tween ®20 | adjuvant | 2 | 1-4 | 1 | 2 | 2 |
| Tween ®80 | adjuvant | 0.5-1 | 0.5-1 | 1 | 0.5-1 | 0.5-1 |
| Ethoxylated Tallow Amine | adjuvant | | | | | |
| (e.g., Adsee ™ 907) | | | | | | |
| Sodium Lauryl Ether | adjuvant | | | | | |
| sulfate | | | | | | |
| Methylated Rapeseed oil | adjuvant | | | | | |
| (e.g., AGNIQUE ®) | | | | | | |
| Hasten ™ | adjuvant | | | | | |
| Genapol X-080 Iso- | adjuvant | | 0.1 | | | |
| tridecyl alcohol polyglycol | | | | | | |
| ether (8EO) | | | | | | |
| Dash ® HC | adjuvant | | | 2 | | |
| Tristyrylphenol Ethoxylate | emulsifier | | | | | |
| (e.g., Soprophor ®Bsu by | | | | | | |
| Solvay) | | | | | | |
| AG-HRO ® Fkc 1000 by | Adjuvant | | | | | |
| Solvay | | | | | | |
| 1-methyl-2-pyrolidone | solubilizer | 1.4 | 0.35-1.4 | 0.7-1.4 | 1.4 | 1.4 |
| (NMP) | | | | | | |
| acetophenone | solubilizer | 8.6 | 2.15-8.6 | 4.3-8.6 | 8.6 | 8.6 |
| acetone | solubilizer | | 24 | | | |
| Xylene | solubilizer | | | 8.6 | 2 | 2 |
| Dimethylsulfoxide (DMSO) | solubilizer | 2 | 1-6 | 2 | 0.5-2 | 0.5-2 |
| Ethyl lactate | solubilizer | | 6 | | | |
| 50 mM Tris Buffer pH = 8 | solubilizer | ✓ | | ✓ | ✓ | ✓ |
| 0.8-6.4 mM Potassium | solubilizer | | | | | |
| hydroxide, pH = 8-9 | | | | | | |
| 1-5.2 mM Ammonium | solubilizer | | | | | |
| hydroxide, pH = 8-9 | | | | | | |
| 5-11 mM Mono-Iso- | solubilizer | | | | | |
| Propyl-Amine (MIPA), | | | | | | |
| pH = 7-9 | | | | | | |

The obtained data indicated that for compounds that feature a carboxylic acid group or a “prodrug thereof”, a preferred solubilizing medium is a medium in which the acid is ionized. The medium can be a buffer that features pH of 7-9, in which the carboxylic acid group is ionized, or a metal hydroxide-containing aqueous medium, in which the hydroxide concentration is around a stoichiometric ratio relative to the compound.

The obtained data further indicated that an emulsion medium, containing an organic solvent and water and one or more emulsifiers, provides the best performance. While several organic solvents and several emulsifiers were tested, it was seen that a mixture of acetophenone and NMP at a ratio of about 4:1 and a total concentration of up to 10% (e.g., 8.6% acetophenone and 1.4% NMP) provides the best results, and that an emulsifier system that comprises 0.5% ECO and 0.5% Ca-LAS is preferred.

A list of possible adjuvants and combinations thereof was also tested (see Tables 1A and 1B). It was uncovered that for all tested compounds, an inclusion of a Tween® (polysorbate-type) adjuvant, such as Tween®20 and/or Tween®80, at a concentration of at least 1% is preferred (since formulations lacking this component typically exhibited lower performance).

In further assays, Compound 1 was dissolved in an aqueous medium containing either MIPA or Ammonium hydroxide, as indicated in Table 2.

TABLE 2

| | Formulation for | Formulation for |
|---|---|---|
| Treatment | application on A. palmeri | application on S. viridis |
| Compound 1 | 0.5 mg/ml | 1 mg/ml |
| Ammonium | 0.007% | 0.015% |
| hydroxide | | |
| MIPA | 0.019% | 0.037% |

Each of the obtained solution was then mixed with different adjuvants and applied at a rate equivalent to 500 g/ha for A. palmeri and 1000 g/ha for S. viridis. Herbicidal activity scores 3-4 days after application are presented Table 3 below.

TABLE 3

| Treatment | | A. palmeri | S. viridis |
|---|---|---|---|
| Ammonium | 2% Tween ®20 | 60 | 80 |
| Hydroxide | 0.25% Adsee | 30 | 10 |
| | 0.25% Genapol X-080 | 50 | 70 |
| | 0.7% Sodium Lauryl | 85 | 100 |
| | Ether sulfate | | |
| | 1% AGNIQUE, 0.05% | 70 | 70 |
| | Ca-LAS, 0.02% BSU | | |
| MIPA | 2% Tween ®20 | 95 | 100 |
| | 0.25% Adsee | 80 | 40 |
| | 0.25% Genapol X-080 | 70 | 100 |
| | 0.7% Sodium Lauryl | 90 | 100 |
| | Ether sulfate | | |
| | 1% AGNIQUE, 0.05% | 80 | 70 |
| | Ca-LAS, 0.02% BSU | | |

As can be generally seen, the activity obtained with all the tested adjuvants, except Adsee, was comparable.

### Herbicidal Activity:

The herbicidal activity of each of the leading anthraquinones, each in various formulations, concentration and application rates, was tested as described hereinabove.

Tables 4 and 5 present the data obtained for treatment of Amaranthus palmeri (A. palmeri; Table 4), and for treatment of Setaria viridis (S. viridis; Table 5), with selected formulations and application rates as indicated therein.

TABLE 4

| | | Rate | Activity |
|---|---|---|---|
| Compound | Formulation | (g/ha) | Score |
| Compound 1 | 1% TWEEN ®80, 0.05M Tris buffer | 1000 | 100 |
| | pH 8, 0.05% Break-Thru | | |
| Compound 1 | 1% TWEEN ®80, 0.05M Tris buffer | 2000 | 95 |
| | pH 8, 0.05% Break-Thru | | |
| Compound 1 | 4% TWEEN ®20, 0.05M Tris buffer | 1500 | 95 |
| | pH 8, 0.05% Break-Thru | | |
| Compound 1 | 2% TWEEN ®20, 5 mM MIPA, | 500 | 95 |
| | 1% AGNIQUE, 0.05% Ca-LAS, | | |
| | 0.02% BSU, 0.05% Break-Thru | | |
| Compound 4 | 8.6% Acetophenone, 4% | 1500 | 95 |
| | TWEEN ®20, 1.4% NMP, 0.5% | | |
| | ECO, 0.5% Ca-LAS, 0.05% | | |
| | Break-Thru | | |
| Compound 4 | 8.6% Acetophenone, 1% | 1000 | 95 |
| | TWEEN ®80, 1.4% NMP, 0.5% | | |
| | ECO, 0.5% Ca-LAS, 0.05% | | |
| | Break-Thru | | |
| Compound 2 | 2% DMSO, 1% TWEEN ®80, | 2000 | 100 |
| | 0.05M Tris buffer pH 8, | | |
| | 0.05% Break-Thru | | |
| Compound 2 | 8.6% Acetophenone, 1% | 1000 | 95 |
| | TWEEN ®80, 1.4% NMP, 0.5% | | |
| | ECO, 0.5% Ca-LAS, 0.05% | | |
| | Break-Thru | | |
| Compound 2 | 4.3% Acetophenone, 1% | 500 | 100 |
| | TWEEN ®80, 0.7% NMP, 0.25% | | |
| | ECO, 0.25% Ca-LAS, 0.05% | | |
| | Break-Thru | | |
| Compound 6 | 8.6% Acetophenone, 1% | 1500 | 75 |
| | TWEEN ®80, 1.4% NMP, 0.5% | | |
| | ECO, 0.5% Ca-LAS, 0.05% | | |
| | Break-Thru | | |
| Compound 5 | 8.6% Acetophenone, 2% | 2000 | 70 |
| | TWEEN ®20, 1.4% NMP, 0.5% | | |
| | ECO, 0.5% Ca-LAS, 0.05% | | |
| | Break-Thru | | |
| Compound 7 | 8.6% Acetophenone, 2% | 2000 | 40 |
| | TWEEN ®20, 1.4% NMP, 0.5% | | |
| | ECO, 0.5% Ca-LAS, 0.05% | | |
| | Break-Thru | | |
| Compound 3 | 8.6% Acetophenone, 2% | 2000 | 80 |
| | TWEEN ®20, 1.4% NMP, 0.5% | | |
| | ECO, 0.5% Ca-LAS, 0.05% | | |
| | Break-Thru | | |
| Compound 1A | 2% TWEEN ®20, 0.05M Tris buffer | 1000 | 90 |
| | pH 8.3, 0.05% Break-Thru | | |
| Compound 1B | 2% TWEEN ®20, 0.05M Tris buffer | 500 | 30 |
| (Rhein-8- | pH 8.3, 0.05% Break-Thru | | |
| Glucoside) | | | |
| Compound 1B | 2% TWEEN ®20, 5.7 mM MIPA, | 750* | 70 |
| (Rhein-8- | 0.05% Break-Thru | | |
| Glucoside) | | | |

*Rate adjusted to reflect that of the Rhein actual active ingredient

TABLE 5

| | | Rate | Activity |
|---|---|---|---|
| Compound | Formulation | (g/ha) | Score |
| Compound 1 | 2% TWEEN ®20, 5.2 mM | 1000 | 90 |
| | Ammonium hydroxide, 0.05% | | |
| | Break-Thru | | |
| Compound 4 | 6% DMSO, 0.05% Break-Thru | 1500 | 40 |
| Compound 2 | 2% DMSO, 1% TWEEN ®80, | 1500 | 40 |
| | 0.05M Tris buffer pH 8, 0.05% | | |
| | Break-Thru | | |
| Compound 6 | 8.6% Acetophenone, 1% | 1000 | 80 |
| | TWEEN ®80, 1.4% NMP, 0.5% | | |
| | ECO, 0.5% Ca-LAS, 0.05% | | |
| | Break-Thru | | |
| Compound 3 | 8.6% Acetophenone, 2% | 2000 | 10 |
| | TWEEN ®20, 1.4% NMP, 0.5% | | |
| | ECO, 0.5% Ca-LAS, 0.05% | | |
| | Break-Thru | | |
| Compound 1B | 1% Eta-70, 5.7 mM MIPA, 0.05% | 750* | 50 |
| (Rhein-8- | Break-Thru | | |
| Glucoside) | | | |

*Rate adjusted to reflect that of the Rhein actual active ingredient

In another set of growth-chamber post-emergence experiments, herbicidal activity of the most potent compound for A. Palmeri, Compound 1, was evaluated for additional weeds.

Herbicidal activity of Compound 1 was determined by post-emergence application on 13-day old Echinochloa colonum, Lolium multiflorum and Solanum nigrum.

In each treatment, 3 pots, each containing about 5 plants, were sprayed using the same conditions as described above which are equivalent to 1000 g/ha. Herbicidal activity was assessed and scored 3 days after application by visual inspection of the weeds. Activity score is in the range of 0 to 100, where 0 represents no herbicidal activity like control plants and 100 represents the maximal herbicidal activity (i.e., total death of the plant). The obtained data is presented in Table 6 below per the activity score as described herein.

TABLE 6

| Plant | 1000 g/ha |
|---|---|
| Echinochloa colonum | 70 |
| Lolium multiflorum | 50 |
| Solanum nigrum | 60 |

### Example 3

### Greenhouse Post-Emergence Assays

### Seed Sowing and Experiment Design:

Plant seeds were sowed in 9 cm×9 cm×10 cm flowerpots. Timing of sowing (days before treatment application) for each plant is detailed in Table 7 below. 5 flowerpots of each species were used for each treatment. Seeds were sowed in wet clay soil and then covered with about 1 cm layer of dry clay soil.

TABLE 7

| Plant Specie | Days before application | Seeds per pot |
|---|---|---|
| Amaranthus palmeri | 15 | 12 |
| Solanum nigrum | 20 | 7 |
| Setaria viridis | 15 | 9 |
| Gossypium hirsutum | 28 | 4 |
| Zea mays | 13 | 5 |

Irrigation: Irrigation was carried out using VIBRONET-UD (NETAFIM) sprinklers hanging upside down one meter above the flowerpots. Water flow capacity-50 liters per hour. Irrigation was carried out three times a day for 10 minutes.

Treatments: Table 8 presents generally the protocols of the various treatments used in these assays.

TABLE 8

| No. | Treatment | volume (L/ha) | Dose (g/ha) |
|---|---|---|---|
| 1 | Tris Control | 400 | 0 |
| 2 | Compound 1 | 400 | 1000 |
| 3 | Compound 1 | 400 | 1500 |
| 4 | Emulsion Control | 400 | 0 |
| 5 | Compound 4 | 400 | 1000 |
| 6 | Compound 4 | 400 | 1500 |

### Formulations Preparation:

### Compound 1

### Treatment 1 (Table 8-Tris Control)

4.8 ml of TWEEN®20 were added to 115.2 ml of 0.05 M Tris buffer pH=8 solution to obtain a 4% TWEEN®20 solution. 60 μl of Break-Thru were added to obtain a solution containing 0.05% Break-Thru.

Treatment 2 (Table 8; Compound 1, 2.5 mg/ml (1000 Grams/Hectare))

57.6 ml of 0.05 M Tris buffer pH=8 were added to 150 mg of Compound 1 and the mixture was stirred using a magnetic stirrer. 2.4 ml of TWEEN®20 were added and the mixture was stirred using a magnetic stirrer to obtain a 4% TWEEN®20-containing solution. 30 μl of Break-Thru were added to obtain a 0.05% Break-Thru-containing solution.

Treatment 3 (Table 8; Compound 1, 3.75 mg/ml (1500 Grams/Hectare))

57.6 ml of 0.05 M Tris buffer pH=8 were added to 225 mg of Compound 1 and the mixture was stirred using a magnetic stirrer. 2.4 ml of TWEEN®20 were added and the mixture was stirred using a magnetic stirrer to obtain a 4% TWEEN®20-containing solution. 30 μl of Break-Thru were added to obtain a 0.05% Break-Thru-containing solution.

### Compound 4

### Treatment 4 (Table 8-Emulsion Control)

10.32 ml of Acetophenone and 1.68 ml of 1-methyl-2-pyrrolidone were mixed, and then vortexed and subjected to sonication at 60° C. for 10 minutes. 600 mg of ethoxylated castor oil (ECO; Kolliphor® RH 40) were added and the obtained solution was mixed. 600 mg of Ca-LAS (Rhodacal® 60be) were then added and the mixture was mixed. The whole volume of the obtained solution was then added to 108 ml of 4.6% TWEEN®20 and shaken gently by hand. 60 μl of Break-Thru were then added.

Treatment 5 (Table 8; Compound 4, 2.5 mg/ml (1000 Grams/Hectare))

150 mg Compound 4 were weighed and dissolved in a pre-mixed solution of 5.16 ml of Acetophenone and 840 μl of 1-methyl-2-pyrrolidone. The obtained mixture was vortexed and subjected to sonication at 60° C. for 10 minutes. 300 mg of ECO were then added, followed by 300 mg of Ca-LAS. Upon mixing the whole volume of the obtained solution was added to 54 ml of 4.6% TWEEN®20 solution and the obtained mixture was shaken gently by hand. 30 μl of Break-Thru were then added.

Treatment 6 (Table 8; Compound 4, 3.75 mg/ml (1500 Grams/Hectare)

225 mg Compound 4 were weighed and dissolved in a pre-mixed solution of 5.16 ml of Acetophenone and 840 μl of 1-methyl-2-pyrrolidone. The obtained mixture was vortexed and subjected to sonication at 60° C. for 10 minutes. 300 mg of ECO were then added, followed by 300 mg of Ca-LAS. Upon mixing the whole volume of the obtained solution was added to 54 ml of 4.6% TWEEN®20 solution and the obtained mixture was shaken gently by hand. 30 μl of Break-Thru were then added.

### Treatments Application:

Plants were sprayed using a DeVreis Generation 4 Research Track Sprayer with a TEE JET nozzle 80015EVS. Spraying volume was 200 L/ha using the following sprayer parameters:
Spray speed-2 KMH
Spray length-1.50 m
Spray pressure-42 PSI

Each plant was sprayed twice, yielding a total spraying volume of 400 L/ha. Nozzle was located 55 cm above pots ground level.

A. palmeri, S. viridis and S. nigrum plants were elevated with 8 cm tray, Z. mays plants were elevated with 3 cm tray in order to achieve a similar spraying height for all plant's foliage.

### Damage Assessment:

Plants were scored by visual inspection of symptoms, on a scale of 0-100, where 0 represents no herbicidal activity like control plants and 100 represents the maximal herbicidal activity (i.e., total death of the plant). Each pot was scored separately. The obtained average scores and standard deviations for each treatment (5 pots) is shown in Tables 9 below. DAT=days after treatment

Tables 9 and 10 present preliminary data obtained for treating A. palmeri (Table 9) and Z. mays (Table 10) with Compound 1. demonstrating its selective potency towards weeds.

TABLE 9
A. palmeri

| | Dose | | | | | |
|---|---|---|---|---|---|---|
| Treatment name | (g/ha) | 1 DAT | 3 DAT | 6 DAT | 8 DAT | 15 DAT |
| Tris. Control | | 0 ± 0 | 0 ± 0 | 0 ± 0 | 0 ± 0 | 0 ± 0 |
| Compound 1 | 1000 | 22 ± 13 | 54 ± 11.4 | 36 ± 8.9 | 34 ± 11.4 | 20 ± 15.8 |
| | 1500 | 38 ± 29.5 | 90 ± 9.4 | 87 ± 9.7 | 83 ± 14 | 66 ± 29.7 |

TABLE 10
Z. mays:

| Treatment | Dose | | | | | |
|---|---|---|---|---|---|---|
| name | (g/ha) | 1 DAT | 3 DAT | 6 DAT | 8 DAT | 15 DAT |
| Tris. Control | | 0 ± 0 | 0 ± 0 | 0 ± 0 | 0 ± 0 | 0 ± 0 |
| Compound 1 | 1000 | 0 ± 0 | 30 ± 0 | 20 ± 0 | 22 ± 4.5 | 10 ± 0 |
| | 1500 | 0 ± 0 | 30 ± 0 | 30 ± 0 | 28 ± 4.5 | 20 ± 0 |

### Example 4

### PDA Plate Fungicidal Assay

Compound 1 was dissolved in 0.05 M Tris buffer pH=8 to a concentration of 4 mg/ml, and then diluted with a sterile PDA solution to final concentrations of 40 and 400 μg/ml. 10 ml of each solution were poured to a 100 mm petri dish and left to cool down. A 0.5 cm diameter agar disc inoculated with 3-day old B. cinerea hypha was placed upside down in the center of each PDA plate. Each treatment contained two repeats (two plates). Plates were incubated at 21° C. for 4 days.

Fungicidal activity was scored by measuring the radial growth area of the hypha. Results were recorded 2-4 days after inoculation (DAI). % growth inhibition was calculated relative to control treatment without Compound 1. Averaged values are shown in Table 11 below.

TABLE 11

| Compound 1 | 2 DAI | 3 DAI | 4 DAI |
|---|---|---|---|
| 40 μg/ml | 61 | 82 | 86 |
| 400 μg/ml | 82 | 88 | 83 |

### Example 5

### Growth-Chamber Assays

Herbicidal activity of Compound 1 was determined by post-emergence application on 8-day old plants (weeds) of the Amaranthus palmeri and Setaria viridis species that were grown at 16 hours/8 hours day/night cycles at 30° C./25° C., respectively. Leaf stage was typically 4-6 for A. palmeri and 3-4 for S. viridis.

In each treatment, between 1 to 3 pots (8×12 cm), containing about 6 Amaranthus palmeri or Setaria viridis plants, were sprayed using a VL-SET Paasche Airbrush with a 1 ml-solution containing 0.1-0.375 mg/ml of the tested compound, which is equivalent to about 100-375 g/ha.

Damage assessment: Herbicidal activity was assessed and scored 3-4 days after application by visual inspection of the plants in comparison to plants treated with the formulation alone (with no active ingredient) as control. Activity score is in the range of 0 to 100, where 0 represents no herbicidal activity like control plants and 100 represents the maximal herbicidal activity (i.e., total death of the plant).

Herbicidal activity scores are presented in Table 12 below, and further demonstrate the high activity of the exemplified compositions, also at low application rates.

TABLE 12

| | Application | | |
|---|---|---|---|
| Formulation | rate (g/ha) | A. palmeri | S. viridis |
| 0.8% MIPA, 2% TWEEN20, 1% AGNIQUE, | 375 | 100 | 75 |
| 0.05% Ca-LAS, 0.02% BSU, 0.05% Break-Thru | | | |
| 0.8% MIPA, 0.25% Genapol, 1% AGNIQUE, | 375 | 97 | 78 |
| 0.05% Ca-LAS, 0.02% BSU | | | |
| 0.02% MIPA, 2% TWEEN20, 2% AGNIQUE, | 250 | 90 | — |
| 0.1% Ca-LAS, 0.04% BSU, 0.05% Break-Thru | | | |
| 0.21% MIPA, 0.25% Genapol, 1% AGNIQUE, | 200 | 93 | 65 |
| 0.05% Ca-LAS, 0.02% BSU | | | |
| 0.8% MIPA, 0.25% Genapol, 1% AGNIQUE, | 200 | 98 | 88 |
| 0.05% Ca-LAS, 0.02% BSU | | | |
| 0.8% MIPA, 0.25% Genapol, 1% AGNIQUE, | 150 | 85 | 70 |
| 0.05% Ca-LAS, 0.02% BSU | | | |
| 0.8% MIPA, 0.25% Genapol, 2% HASTEN | 150 | 85 | 65 |
| 0.8% MIPA, 2% DASH EC | 125 | 65 | 43 |
| 0.8% MIPA, 0.25% Genapol, 2% DASH EC | 125 | 93 | 23 |
| 0.8% MIPA, 0.25% Genapol, 2% DASH EC | 100 | 90 | — |

### Example 6

### Net-House Assays

Compound 1 was further tested in net-house post-emergence assay.

Post-emergence herbicidal activity was tested on Amaranthus palmeri weeds species that were grown in a net-house. Average daily minimum and maximum temperatures during the assay were 20.5° C./51° C., respectively. Leaf stage at the time of application was 3-4. In each treatment, 3 flowerpots (7 cm×7 cm×6 cm) containing about 3-6 plants, were sprayed using a VL-SET Paasche Airbrush with a 1.5 containing 0.75 mg/ml of the tested compound, which is equivalent to 750 g/ha.

Damage assessment: Herbicidal activity was assessed and scored 1-12 days after application by visual inspection of the plants in comparison to plants treated with the formulation alone (with no active ingredient) as control. Activity score is in the range of 0 to 100, where 0 represents no herbicidal activity like control plants and 100 represents the maximal herbicidal activity (i.e., total death of the plant).

Herbicidal activity scores are presented in Table 13 below, further demonstrating the herbicidal activity of exemplary compositions according to the present embodiments.

TABLE 13

| | 1 | 3 | 5 | 7 | 12 |
|---|---|---|---|---|---|
| Formulation | DAT | DAT | DAT | DAT | DAT |
| 0.05% MIPA, 2% TWEEN20, | 95 | 100 | 100 | 100 | 100 |
| 0.05% Break-Thru | | | | | |
| 0.05% MIPA, 2% Hasten, | 95 | 95 | 90 | 90 | 80 |
| 0.05% Break-Thru | | | | | |

### Example 7

### Growth-Chamber Assays

Herbicidal activity of Compound 1 was determined by post-emergence application on various weed species. 8-14 day old plants (weeds) were grown at 16 hours/8 hours day/night cycles at 30° C./25° C., respectively. Leaf stage was typically 2-6.

In each treatment, 3 pots (either 7×7 or 8×12 cm), containing about 3-6 plants each, were sprayed using a VL-SET Paasche Airbrush with a 1-1.5 ml-solution containing 0.5-1.5 mg/ml of the tested compound, which is equivalent to about 500-1500 g/ha.

Damage assessment: Herbicidal activity was assessed and scored 3-4 days after application by visual inspection of the plants in comparison to plants treated with the formulation alone (with no active ingredient) as control. Activity score is in the range of 0 to 100, where 0 represents no herbicidal activity like control plants and 100 represents the maximal herbicidal activity (i.e., total death of the plant).

Herbicidal activity scores are presented in Table 14 below, and demonstrate the wide-spectrum herbicidal activity of exemplary compositions according to the present embodiments.

TABLE 14

| | Formulation | | |
|---|---|---|---|
| | 0.8% MIPA, | 0.2% MIPA, | |
| | 0.25% Genapol, | 2% TWEEN20, | |
| | 1% AGNIQUE, | 1% AGNIQUE, | 0.8% MIPA, |
| | 0.05% Ca-LAS, | 0.05% Ca-LAS, | 0.25% Genapol, |
| | 0.02% BSU, | 0.02% BSU, | 2% HASTEN, |
| | 0.05% | 0.05% | 0.05% |
| | Break-Thru | Break-Thru | Break-Thru |
| Application | 500 | 750 | 1500 |
| rate (g/ha) | | | |
| A. palmeri | 100 | 100 | 100 |
| S. viridis | 70 | 70 | 100 |
| S. nigrum | NA | 95 | 100 |
| A. retroflexus | 85 | NA | NA |
| S. alba | 80 | NA | NA |
| D. ferox | NA | NA | 95 |
| X. strumarium | NA | NA | 90 |
| E. colonum | NA | NA | 90 |
| L. multiflorum | NA | NA | 50 |
| A. theophrasti | NA | NA | 40 |
| T. vulgare | 10 | NA | NA |

### Example 8

### Growth-Chamber Assays

Herbicidal activity of Compounds 1B, 3, 4, 5 and 6 was determined by post-emergence application on 8-day old plants (weeds) of the Amaranthus palmeri and Setaria viridis species that were grown at 16 hours/8 hours day/night cycles at 30° C./25° C., respectively. Leaf stage was typically 4-6 for A. palmeri and 3-4 for S. viridis.

In each treatment, between 1 to 4 pots (8×12 cm), containing about 6 Amaranthus palmeri or Setaria viridis plants, were sprayed using a VL-SET Paasche Airbrush with a 1 ml-solution containing 0.250-2 mg/ml of the tested compound, which is equivalent to about 250-2000 g/ha.

Damage assessment: Herbicidal activity was assessed and scored 3-4 days after application by visual inspection of the plants in comparison to plants treated with the formulation alone (with no active ingredient) as control. Activity score is in the range of 0 to 100, where 0 represents no herbicidal activity like control plants and 100 represents the maximal herbicidal activity (i.e., total death of the plant).

Herbicidal activity scores are presented in Table 15 below, and further demonstrate the high efficacy of exemplary compositions according to the present embodiments.

TABLE 15

| | Application | | | |
|---|---|---|---|---|
| Compound | rate (g/ha) | Formulation | A. palmeri | S. viridis |
| 1B | 1000 | 2% MIPA, 2% DMSO, 0.25% | 100 | 90 |
| | | Genapol, 2% HASTEN | | |
| | 500 | 2% MIPA, 2% DMSO, 0.25% | 100 | 95 |
| | | Genapol, 2% HASTEN | | |
| | 250 | 2% MIPA, 2% DMSO, 0.25% | 85 | 70 |
| | | Genapol, 2% HASTEN | | |
| 3 | 2000 | 2% MIPA, 2% DMSO, 1% | 95 | 100 |
| | | TWEEN20, 2% HASTEN | | |
| | 1000 | 2% MIPA, 2% DMSO, 1% | 95 | 95 |
| | | TWEEN20, 2% HASTEN | | |
| | 500 | 10% Acetone, 1.7% MIPA, 5% | 99 | 88 |
| | | DMSO, 0.85% TWEEN20, | | |
| | | 1.7% HASTEN | | |
| | 250 | 10% Acetone, 1.85% MIPA, | 91 | 63 |
| | | 5% DMSO, 0.23% Genapol, | | |
| | | 1.85% HASTEN | | |
| 4 | 500 | 18.5% Acetone, 2% MIPA, 5% | 95 | 50 |
| | | DMSO, 1% TWEEN20, 2% | | |
| | | HASTEN | | |
| | 330 | 10% Acetone, 0.8% MIPA, 5% | 93 | 75 |
| | | DMSO, 0.25% Genapol, 2% | | |
| | | HASTEN | | |
| | 330 | 10% Acetone, 2% MIPA, 5% | 80 | 88 |
| | | DMSO, 0.25% Genapol, 2% | | |
| | | HASTEN | | |
| | 330 | 5% Acetone, 2% MIPA, 2.5% | 88 | 80 |
| | | DMSO, 0.25% Genapol, 2% | | |
| | | HASTEN | | |
| | 250 | 14% Acetone, 2% MIPA, 5% | 90 | 90 |
| | | DMSO, 1% TWEEN20, 2% | | |
| | | HASTEN | | |
| | 250 | 10% Acetone, 1.85% MIPA, | 85 | 45 |
| | | 5% DMSO, 0.23% Genapol, | | |
| | | 1.85% HASTEN | | |
| 5 | 2000 | 2% MIPA, 1% TWEEN20, 2% | 100 | 90 |
| | | HASTEN | | |
| | 1000 | 2% MIPA, 2% DMSO, 1% | 95 | 75 |
| | | TWEEN20, 2% HASTEN | | |
| 6 | 2000 | 2% MIPA, 2% DMSO, 1% | 90 | 95 |
| | | TWEEN20, 2% HASTEN | | |
| | 1000 | 2% MIPA, 2% DMSO, 1% | 70 | 90 |
| | | TWEEN20, 2% HASTEN | | |
| | 500 | 18.5% Acetone, 2% MIPA, 5% | 70 | 40 |
| | | DMSO, 1% TWEEN20, 2% | | |
| | | HASTEN | | |
| | 250 | 14% Acetone, 2% MIPA, 5% | 10 | 90 |
| | | DMSO, 1% TWEEN20, 2% | | |
| | | HASTEN | | |

### Example 9

Growth-Chamber and Net-House Assays with Resistant Weeds

Herbicidal activity of Compound 1 was determined by post-emergence application in both Growth-chamber and Net-house conditions. Growing conditions were as described in Examples 6 and 8 above.

### Growth-Chamber Assays:

The assay was performed on 9-11 day old plants (weeds) of Amaranthus rudis that were either target-site resistant or sensitive to HRAC class 5. In each treatment, between 1 to 3 pots (8×12 cm), containing about 6 Amaranthus Rudis plants, were sprayed using a VL-SET Paasche Airbrush with a 1 ml-solution.

Damage assessment: Herbicidal activity was assessed and scored 4-5 days after application by visual inspection of the plants in comparison to plants treated with the formulation alone (with no active ingredient) as control. Activity score is in the range of 0 to 100, where 0 represents no herbicidal activity like control plants and 100 represents the maximal herbicidal activity (i.e., total death of the plant).

Herbicidal activity scores are presented in Table 16 below and demonstrate the superior efficacy of an exemplary composition according to some of the present embodiments, and particular the herbicidal activity on resistant herbs.

TABLE 16

| | Application | Sensitive | Resistant |
|---|---|---|---|
| Ttreatment | rate (g/ha) | A. rudis | A. rudis |
| Compound 1 | 2,000 | 100 | 100 |
| Prometrex (prometryn) 1X | 750 | 65 | 0 |
| Prometrex (prometryn) 2.7X | 2,000 | 100 | 0 |
| Prometrex (prometryn) 3X | 2,250 | — | 0 |

### Net-House Assays:

The assay was performed on 13-15 day old plants (weeds) of Amaranthus rudis that were either target-site resistant or sensitive to HRAC class 5. In each treatment, 3 pots (8×12 cm), containing about 6 Amaranthus Rudis plants, were sprayed using a VL-SET Paasche Airbrush with a 1 ml-solution.

Damage assessment: Herbicidal activity was assessed and scored 13 days after application by visual inspection of the plants in comparison to plants treated with the formulation alone (with no active ingredient) as control. Activity score is in the range of 0 to 100, where 0 represents no herbicidal activity like control plants and 100 represents the maximal herbicidal activity (i.e., total death of the plant).

Herbicidal activity scores are presented in Table 17 below and further demonstrate the herbicidal activity on resistant herbs.

TABLE 17

| | Application | Sensitive | Resistant |
|---|---|---|---|
| Ttreatment | rate (g/ha) | A. rudis | A. rudis |
| Compound 1 | 1,500 | 100 | 100 |
| Atranex (Atrazine) 1X | 300 | 100 | 0 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-51. (canceled)

52. A herbicidal composition comprising an agriculturally acceptable carrier and a compound represented by Formula Ia: 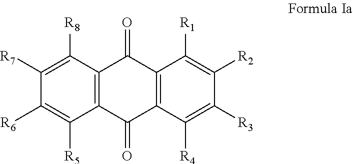
wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is —C(═O)—OR₁₀;
R₄ is selected from hydrogen, OR₉ and amine;
R₅-R₇ are each hydrogen;
R₉ is selected from hydrogen, a saccharide, and —C(═O)—R₁₁;
R₁₀ is selected from hydrogen and alkyl; and
R₁₁ is alkyl.

53. The herbicidal composition of claim 52, wherein said carrier is an aqueous carrier.

54. The herbicidal composition of claim 52, wherein R₁ and R₈ are each independently OR₉.

55. The herbicidal composition of claim 52, wherein R₁ and R₈ are each OR₉, and wherein each R₉ is hydrogen.

56. The herbicidal composition of claim 52, wherein R₁ and R₈ are each OR₉, and wherein each R₉ is —C(═O)—R₁₁.

57. The herbicidal composition of claim 52, wherein R₁ and R₈ are each independently OR₉, and wherein in at least one of said OR₉, R₉ is a saccharide.

58. The herbicidal composition of claim 52, wherein R₄ is OR₉.

59. The herbicidal composition of claim 52, wherein R₁, R₂ and R₅-R₈ are each hydrogen.

60. The herbicidal composition of claim 52, wherein the compound is selected from Compound 1, Compound 1A, Compound 1B, Compound 2 and Compound 3.

61. The herbicidal composition of claim 52, wherein said aqueous carrier is in a form of an emulsion and further comprises an organic solvent.

62. The herbicidal composition of claim 61, wherein said organic solvent comprises at least one polar aprotic organic solvent.

63. The herbicidal composition of claim 62, wherein said organic solvent comprises a mixture of a ketone and a pyrrolidone.

64. The herbicidal composition of claim 61, wherein an amount of said organic solvent ranges from 5 to 20%, by weight, of the total weight of the composition.

65. The herbicidal composition of claim 61, wherein said carrier further comprises at least one emulsifier.

66. The herbicidal composition of claim 65, wherein an amount of said at least one emulsifier ranges from 0.1 to 2% by weight of the total weight of the composition.

67. The herbicidal composition of claim 52, wherein said carrier is an aqueous carrier and further comprises:
from about 1 to about 20, or from about 5 to about 15, % by weight of an organic solvent that comprises a mixture of a ketone and a pyrrolidone at a weight ratio that ranges from 2:1 to 6:1;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition; and, optionally,
a polyether-modified polysiloxane emulsifier in an amount that ranges from 0.01 to 0.1, or of about 0.05, % by weight, of the total weight of the composition.

68. The herbicidal composition of claim 52, wherein said carrier comprises an alkaline substance.

69. The herbicidal composition of claim 68, wherein a mol ratio of said alkaline substance to said compound ranges from 2:1 to 1:1 or is about 1.

70. The herbicidal composition of claim 52, further comprising at least one adjuvant.

71. The herbicidal composition of claim 70, wherein a total amount of said at least one adjuvant ranges from about 0.1% to about 10%, by weight of the total weight of the composition.

72. The herbicidal composition of claim 52, wherein said carrier is an aqueous carrier and further comprises:
an alkaline substance in a mol ratio of from 2:1 to 1:1 relative to the compound of Formula Ia; and
at least one adjuvant that comprises a non-ionic surfactant in an amount of from 0.1 to 5% by weight of the total weight of the composition.

73. A herbicidal composition comprising an agriculturally acceptable carrier and a compound represented by Formula I: 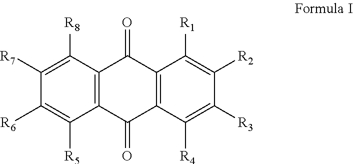
wherein:
R₁ and R₈ are each independently selected from hydrogen, OR₉, —C(═O)—OR₁₀, and amine;
R₂ is selected from hydrogen, OR₉, and —C(═O)—OR₁₀;
R₃ is selected from hydrogen, OR₉, —C(═O)—OR₁₀, and hydroxyalkyl;
R₄ is selected from hydrogen, OR₉ and amine;
R₅ and R₇ are each hydrogen;
R₆ is selected from hydrogen and alkyl;
R₉ is selected from hydrogen, a saccharide, and —C(═O)—R₁₁;
R₁₀ is selected from hydrogen and alkyl; and
R₁₁ is alkyl,
provided that:
at least one of R₁, R₂, R₃ and R₈, or at least R₃, is —C(═O)—OR₁₀; or
at least one of R₁ and R₄ is amine; or
when R₃ is hydroxyalkyl, each of R₁ and R₈ is other than OR₉ wherein R₉ is hydrogen or saccharide; or
when R₁ is OR₉ wherein R₉ is hydrogen, each of R₂-R₈ is hydrogen; or
R₃ is other than OR₉,
wherein said carrier is an aqueous carrier, said aqueous carrier being in a form of an emulsion and further comprises an organic solvent, at least one emulsifier and at least one adjuvant,
wherein said organic solvent comprises at least one polar aprotic organic solvent;
an amount of said organic solvent ranges from about 5 to about 20, or from about 5 to about 15, % by weight, of the total weight of the composition;
said at least one emulsifier is in an amount that ranges from 0.1 to 2% by weight of the total weight of the composition; and
said at least one adjuvant is in an amount that ranges from about 0.1% to about 10%, by weight of the total weight of the composition.

74. The herbicidal composition of claim 73, wherein said organic solvent comprises at least one polar aprotic organic solvent.

75. The herbicidal composition of claim 74, wherein said organic solvent comprises a mixture of a ketone and a pyrrolidone.

76. The herbicidal composition of claim 75, wherein a weight ratio of said ketone and said pyrrolidone ranges from 2:1 to 10:1, or from 2:1 to 6:1.

77. The herbicidal composition of claim 73, wherein said at least one emulsifier comprises an alkyl sulfonate, an aryl sulfonate and/or and alkaryl sulfonate.

78. The herbicidal composition of claim 73, wherein said at least one emulsifier comprises an ethoxylated oil.

79. The herbicidal composition of claim 73, wherein said carrier is an aqueous carrier and further comprises:
from about 5 to about 20, or from about 5 to about 15, % by weight of an organic solvent that comprises a mixture of a ketone and a pyrrolidone at a weight ratio that ranges from 2:1 to 6:1;
at least one aryl sulfonate emulsifier in an amount of from 0.1 to 1, or of about 0.5, % by weight, of the total weight of the composition; and
at least one ethoxylated mineral oil emulsifier, in an amount of from 0.1 to 1, or of about 0.5, % by weight, of the total weight of the composition.

80. The herbicidal composition of claim 73, wherein the compound is selected from Compound 4, Compound 5, Compound 6, and Compound 7.

81. A method of controlling a growth of a plant substrate, the method comprising contacting the plant substrate with the herbicidal composition of claim 52.

82. A method of inhibiting a growth of a herb, the method comprising contacting the weed with the herbicidal composition of claim 52.

83. A method of inhibiting a growth of a herb, the method comprising contacting the weed with the herbicidal composition of claim 73.
